(19) United States
(12) Patent Application Publication
(10) Pub. No.: US 2022/0006096 A1
(43) Pub. Date: Jan. 6, 2022

(54) FLUID-PERMEABLE ELECTRODES, FLUID-PERMEABLE ELECTROCHEMICAL CELLS AND INTEGRATED FLUID-PERMEABLE ANALYTICAL DEVICES, AND FLUID-PERMEABLE DEVICES FOR ELECTROCATALYTIC CONVERSION AND ELECTROSYNTHESIS, AND FOR FLUID DECONTAMINATION

(71) Applicant: The University of Massachusetts, Boston, MA (US)

(72) Inventors: Dionysios Christodouleas, Winchester, MA (US); Abbas Parvez Kazi, Lowell, MA (US); Anna Maria Routsi, Lowell, MA (US)

(21) Appl. No.: 17/365,844

(22) Filed: Jul. 1, 2021

Related U.S. Application Data
(60) Provisional application No. 63/046,817, filed on Jul. 1, 2020.

(51) Int. Cl. H01M 4/86; H01M 8/1007; C25B 11/031

(52) U.S. Cl. CPC H01M 4/861; C25B 11/031; H01M 8/1007

(57) ABSTRACT

Provided is a fluid-permeable electrode having an open-cell structure and having: a layer of an electroactive material deposited on a surface of an open cell substrate that is formed of a material that differs from the electroactive material; or a fluid-permeable electrode having an open-cell structure and consisting of an electroactive material.

### BACKGROUND

The disclose embodiments relate to electrodes, device including the same and methods utilizing the same, and more specifically to fluid-permeable electrodes, fluid-permeable electrochemical cells and integrated fluid-permeable analytical devices, fluid-permeable devices for: electrocatalytic conversion and electrosynthesis, and fluid decontamination.

### BRIEF SUMMARY

Disclosed is a fluid-permeable electrode having an open-cell structure and comprising a layer of an electroactive material deposited on the surface of an open-cell substrate structure (wire mesh, wire cloth, screen, metallic foam etc.) that can be electroconductive or not.

In addition to one or more of the above disclosed aspects, or as an alternate, the open-cell substrate structure (e.g., electroconductive wire mesh or electroconductive foam etc) comprises metals (e.g., copper, brass, nickel, bronze, iron and its alloys, copper and its alloys, zinc and its alloys, chromium and its alloys, nickel and its alloys, steel or stainless steel etc.), carbon (e.g., carbon felt etc.), plastic (mesh, screen etc.).

In addition to one or more of the above disclosed aspects, or as an alternate, the electroactive material comprises a noble metal, noble metal alloy, metallic nanoparticles or electroconductive polymer.

In addition to one or more of the above disclosed aspects, or as an alternate, the electroactive material comprises a transition metal (gold, platinum, silver, palladium, rhodium alloys of metals), silver chloride, carbon, graphene, carbon nanotubes, or a conductive polymer.

In addition to one or more of the above disclosed aspects, or as an alternate, the electroactive material further comprises nanoparticles of transition metals (e.g., gold nanoparticles, silver nanoparticles), or porous structures (such as zeolites).

In addition to one or more of the above disclosed aspects, or as an alternate, the layer of electroactive material is applied by screen printing, electrodeposition, chemical vapor deposition, dip coating, sputtering, or atomic layer deposition.

A sensor is disclosed, including a fluid-permeable electrode that comprises a flexible substrate.

In addition to one or more of the above disclosed aspects, or as an alternate, the flexible substrate comprises paper, fabric or plastic screen.

In addition to one or more of the above disclosed aspects, or as an alternate, the sensor is in the form of an analyte sensor.

In addition to one or more of the above disclosed aspects, or as an alternate, the analyte sensor senses a biomolecule, a metabolite, an enzyme, a protein, antibodies, a metal, metal ions, bacteria, DNA, RNA, vector, or organic pollutants, pesticides, volatile compounds etc.

In addition to one or more of the above disclosed aspects, or as an alternate, the analyte sensor senses glucose.

A fluid-permeable electrochemical flow cell is disclosed, including a fluid-permeable electrode having one or more of the above disclosed aspects, and a fluid, the electrode and the fluid disposed inside a compartment comprising an inlet port and an outlet port.

In addition to one or more of the above disclosed aspects, or as an alternate, the fluid-permeable electrode is a working electrode, and the fluid-permeable electrochemical cell further includes a reference electrode and or a counter electrode.

In addition to one or more of the above disclosed aspects, or as an alternate, the fluid is a gas or a liquid.

A fluid-permeable analytical device for the detection of an analyte is disclosed, including a fluid-permeable electrochemical flow cell having one or more of the above disclosed aspects.

A fluid-permeable device for the decontamination of liquids is disclosed, including a fluid-permeable electrochemical flow cell having on or more of the above disclosed aspects.

A fluid-permeable electrode having an open-cell structure and consisting of an electroactive material, and including one or more of the above disclosed aspects, is disclosed.

Further disclosed is a device comprising the ECC disclosed above, operatively coupled to a syringe, with a sample in solution disposed therein and/or a reagent disk disposed in the solution, wherein the ECC is electrically coupled to a potentiostat, which is operatively connected to an electronic device, whereby the device is configured to capture information regarding the sample while the solution is urged out of the syringe and through the ECC.

Further disclosed is a method of detecting analyte in liquid samples, comprising: filling the syringe of the device disclosed above with a liquid sample of one or more of environmental water; drinking water; food extracts; whole blood; serum; urine; and plasma; wherein the reagent disk includes one or more of buffers, reagents; and urging the liquid sample through the ECC, thereby determining via potentiostat a concentration of one or more analyte; in the liquid sample, the one or more analyte including biomolecule, metabolite, an enzyme, a protein, an antibody, a metal, metallic ions, bacteria, pesticides, or an organic pollutant or organic compounds; and graphing data representing the output of the potentiostat on the external device to thereby illustrate the concentration.

Further disclosed is a device comprising the ECC disclosed above, operatively coupled to a conduit for receiving a gas, and the EEC being operatively coupled to a syringe with a solution disposed therein and/or a reagent disk disposed in the solution, wherein the ECC is electrically coupled to a potentiostat, which is operatively connected to an electronic device, whereby the device is configured to capture information regarding the gas while the solution is urged out of the syringe and through the ECC.

Further disclosed is a method of detecting analyte in a gas, comprising directing a gas into the conduit of the device disclosed above; wherein the reagent disk includes one or more of buffers, and reagents; and urging the solution through the ECC, thereby determining via potentiostat a concentration of one or more analyte in the gas, the one or more analyte including an organic pollutant or organic compounds, and graphing data representing the output of the potentiostat on the external device to thereby illustrate the concentration.

Further disclosed is a device comprising the ECC disclosed above, operatively coupled to a syringe with a fluid and disinfectant disposed therein and a disinfectant disposed in the solution, wherein the ECC is electrically coupled to a power source, whereby the device is configured to decontaminate the fluid gas while the fluid is urged out of the syringe and through the ECC.

Further disclosed is a method of detecting analyte in a gas, comprising filling the syringe of the device disclosed above with a fluid and a disinfectant; urging the fluid through the ECC, thereby decontaminating the fluid; and collecting from the ECC the fluid that is decontaminated.

### BRIEF DESCRIPTION OF THE DRAWINGS

The present disclosure is illustrated by way of example and not limited in the accompanying figures in which like reference numerals indicate similar elements.

FIGS. 1A-1I show various fluid-permeable electrodes according to embodiments;

FIG. 1J shows a beaker type electrochemical cell (show a diagram with all three electrodes) 2A according to embodiments;

FIG. 2A shows voltammograms of solutions of Pb²⁺ ions (0, 5, 10, 15, 20, 30, 40, 50 μg/L), 0.1 M PBS (pH 7) using an Ag wire-mesh electrode;

FIG. 2B shows a linear calibration plot for Pb²⁺ ions detection;

FIG. 2C shows voltammograms of samples containing different concentrations of nitrobenzene (0, 20, 30, 40, 50 μM) in 0.1 M PBS (pH 7) using Au wire-mesh electrode;

FIG. 2D shows a linear calibration plot for nitrobenzene detection;

FIG. 2E shows cyclic voltammograms in the absence and presence of 1 M methanol in 0.5 M H₂SO₄ solution at a scan rate of 50 mV/s using a Pt wire-mesh electrode;

FIG. 3A shows a three-dimensional exploded model of the flexible, fluid-permeable electrochemical sensors for wearables according to embodiments;

FIG. 3B shows an assembly image of the working prototype of the wearable, flexible, fluid-permeable electrochemical cell according to embodiments;

FIG. 3C shows an image of the electrochemical cell opened to show the configuration of the electrodes inside the cell according to embodiments;

FIG. 4A shows an exploded view of an example of a paper-based electrochemical device that utilizes three fluid permeable electrodes according to embodiments;

FIG. 4B shows an assembly view of an example of a paper-based electrochemical device that utilizes three fluid permeable electrodes according to embodiments;

FIG. 5A shows an assembly view of cell 5A which is a fluid permeable electrochemical cell (ECC) according to embodiments;

FIG. 5B shows an explode view of the cell 5A according to embodiments;

FIG. 5C shows a cell with threaded inlet and outlet body portions according to embodiments;

FIG. 5D shows a cell with friction-fit inlet and outlet body portions according to embodiments;

FIGS. 5E and 5F are alternatives to the configurations in FIGS. 5C-5D;

FIG. 6A shows the cell connected to a syringe to deliver a sample according to embodiments;

FIG. 6B shows the cell connected to a syringe filter, to filter a sample and a syringe to deliver the sample according to embodiments;

FIG. 6C shows the cell connected to a plurality of tubes, e.g., first and second tubes, to allow the use of the cell in flow-based systems according to embodiments;

FIG. 6D shows a plurality of the cells connected in series according to embodiments;

FIG. 7A shows a sensor according to embodiments;

FIG. 7B shows reagents which have been deposited onto a piece of paper or fabric (e.g., polyester) and let dry to form a reagent disk according to an embodiment;

FIG. 7C shows the reagent disk within a syringe according to an embodiment;

FIG. 7D shows the syringe, with the reagents dissolved in solution, during a test of the sample according to an embodiment; FIG. 7E is an alternative to the configuration of FIG. 7D;

FIGS. 8A-8B show a fluid control device;

FIG. 9 shows a configuration in which where one or more devices can be connected to a system that pumps solution through them like a syringe pump or a peristaltic pump;

FIG. 10 shows an electrochemical device to decontaminate water and biological samples according to embodiments;

FIG. 11A is a schematic diagram of an undivided electrochemical cell according to embodiments;

FIG. 11B is a schematic diagram of a divided electrochemical cell according to embodiments;

FIG. 12A1-12A2 show a system for volatile organic compounds (VOC) detection in gas samples;

FIG. 12B1-12B2 show a system for analyzing breath of a person;

FIGS. 12C-12D show readouts from tests of a breath;

FIGS. 13A-13D show SEM (scanning electron microscope) images of Cu wire mesh (with three leads) plated at different potentials vs. Ag/AgCl reference electrode;

FIG. 14A shows a photograph of silver/silver chloride electrode;

FIG. 14B shows a SEM image of silver chloride region of the electrode;

FIG. 14C shows morphology of silver chloride deposits on the electrode;

FIG. 15A shows an image of the chamber while graphene is deposited on the copper meshes;

FIG. 15B shows an image of the graphene permeable electrode;

FIG. 15C shows an SEM of graphene deposits on the surface of the copper substrate;

FIG. 16A shows cyclic voltammograms in solution of 5 mM [Fe(CN)₆]^{-3/-4} in 0.1 M KCl at various scan rates for Au-plated Cu mesh a −0.6 V;

FIG. 16B shows a logarithmic of the intensity of anodic peak current (iₚₐ) vs. scan rate for Au-plated Cu mesh at −0.6 V;

FIG. 16C shows cyclic voltammograms in solutions of [Fe(CN)₆]^{-3/-4} and [Fe(CN)₆]^{-3/-4} in 0.1 M in various concentrations, 50 mV/s for Au-plated Cu mesh at −0.6 V. All measurements vs. Ag/AgCl electrodes, Platinized Titanium counter electrode;

FIG. 16D shows a calibration line peak current vs. concentration of [Fe(CN)₆]^{-3/-4} in 0.1 M KCl for Au plated Cu mesh at −0.6 V;

FIGS. 16E-G show a cyclic voltammogram of mixture of 5 mM [Fe(CN)₆]^{-3/-4} in 0.1 M KCl from the graphene (FIG. 16E), PEDOT (FIG. 16F), or PANI (FIG. 16G) permeable working electrodes, at a scan rate equal to 50 mV/s;

FIGS. 17A-C show oxidation levels of solutions of heavy metals obtained using filter-like ECCs;

FIGS. 18A-C, which show oxidation peaks of vapors of volatile compounds recorded on filter-like;

FIG. 19A shows calibration curves for the detection of lead ions using fluid-permeable ECCs;

FIG. 19B, shows calibration curves for the detection of aniline vapors using fluid-permeable ECCs; and

FIG. 20 shows a schematic of the bioassay for bacteria detection.

### DETAILED DESCRIPTION

Design, fabrication, and applications of three-dimensional, fluid-permeable electrodes

Relatively inexpensive substrates like wire mesh (also called screen, wire cloth, etc.) (woven wire mesh, hex wire mesh, welded wire mesh, etc.), metallic mesh or screen, non-conductive mesh, fabric, felt, metallic foams can be used as different inexpensive substrates for the fabrication of electrodes. The wire mesh can be of different wire diameters, mesh number (10, 20, 80, 100, 200, etc.), different weaving type (simple weave, crimp, lock crimp wire mesh, etc.), welded. Metallic mesh or screen can be of different types such as mesh or screen defining rectangular, square, or other shape of apertures; perforated metal sheet (with aligned or staggered perforations); expanded metal sheet, etc. Non-conductive mesh can be made of plastic, ceramic, etc. Fabric can be any fabric of any weave form, or electrically conductive fabric with metallic wires, or electrically conductive particles, or micro or nanoparticales embedded, or weaved therein. The metallic foams can be composed of different thickness, opening size, porosity, wire diameter, etc. All substrates can be composed of metals like copper and copper alloys, nickel and nickel alloys, iron and iron alloys, steel, stainless steel, aluminum and aluminum alloys, zinc and zinc alloys, etc.

The substrates can be coated using chemical deposition techniques (chemical vapor deposition, dip coating, etc.), physical deposition techniques (physical vapor deposition, sputtering, etc.), electrochemical deposition techniques (electroplating, electroless plating, etc.) to have a thin or thick layer of electroactive material. The material may not be active electrically after coating initially, but becomes electroactive after a pre-treatment process (chemical, or physical), or applying an external potential, energy source, etc.

The electroactive material that can be coated on the surface of the inexpensive substrate are transition metals, noble metals (like gold, silver, platinum, palladium), nanomaterials (like gold nanoparticles, silver nanoparticles, or other nanoparticles that are electrically conductive etc.), conductive polymers (like PEDOT, PANI, etc.) and other materials such as graphene, carbon nanotubes Their surface can be modified with materials like nanoparticles, zeolites, aptamers, biomolecules, etc.

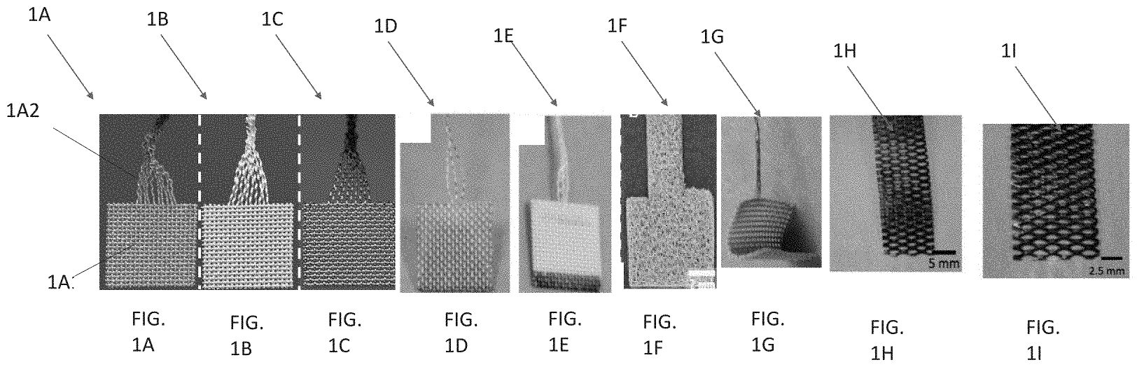

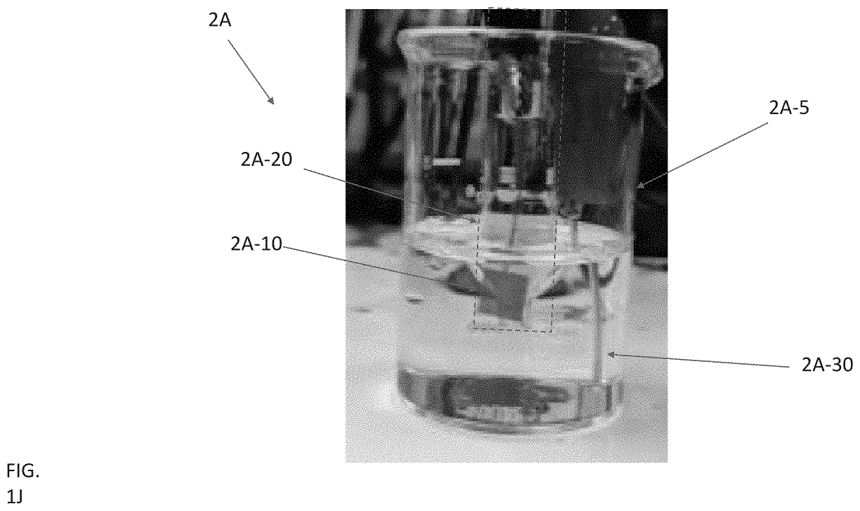

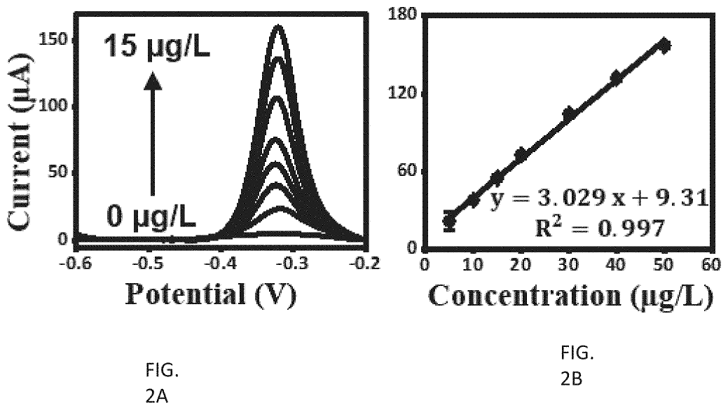

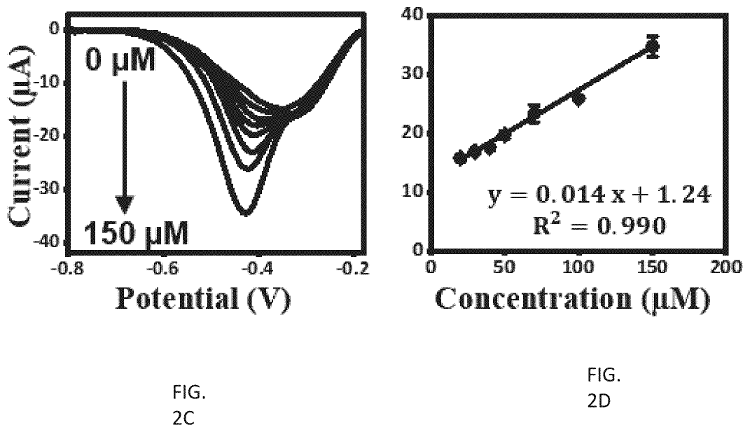

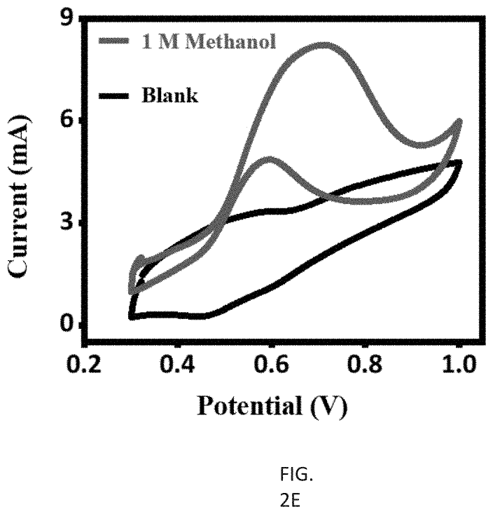

FIGS. 1A-1G shows various fluid-permeable electrodes according to embodiments. Specifically, FIG. 1A shows a first electrode 1A that is an Au (from its symbol on the periodic table of elements) plated mesh electrode. FIG. 1B shows a second electrode 1B that is an Ag plated mesh electrode. FIG. 1C shows a third electrode 1C that is a Pt plated mesh electrode. FIG. 1D shows a fourth electrode 1D that is a graphene mesh electrode. FIG. 1E shows a fifth electrode 1E that is an Ag/AgCl plated mesh electrode. FIG. 1F shows a sixth electrode 1F that is an Au plated metal foam electrode. FIG. 1G shows a seventh electrode 1G that is an Au plate mesh electrode, which is bent to show relative flexibility. FIG. 1H shows an eighth electrode 1H that a is PEDOT poly(3,4-ethylenedioxythiophene) coated electrode. FIG. 1I shows a ninth electrode 1I that is a PANI (polyaniline) coated electrode.

Each of the above electrodes, except 1E, is primarily used as a working or counter electrode. The electrode of 1E is primarily used as a reference electrode.

Each of these electrodes is shown as a body, e.g., 1A1 (FIG. 1A) of substantially 6 mm square mesh with a conductive lead, e.g., 1A2 (FIG. 1) extending away from the body. Flexible can be defined as substrate that is foldable, formable in any desirable geometry or shape like a helix etc. with pressure or otherwise, conformable, or deformable. For example, the material may be resilient, e.g., it may undergo elastic deformation when folding and deforming. As shown in FIG. 1G, a planar formation of the material may bend greater than ninety degrees without permanent deformation.

Regarding the electrodes of FIGS. 1A-1I, the three-dimensional open-cell electrodes that are provided by the disclosed embodiments (FIGS. 1A-1I) have an open cell, fluid-permeable geometry (e.g., wire mesh, metallic foam), are conformable, are highly conductive (conductivity>10² S/cm), and exhibit an electroactive surface that can facilitate electrochemical reactions for sensing applications, electrocatalytic conversions, chemical synthesis and chemical conversions. The three-dimensional, fluid-permeable, electrodes are composed either entirely of (e.g., so that they consist of) an electroactive material (gold, silver, platinum, transition metal, etc.) or are composed of a three-dimensional, open-cell support structure (wire mesh, metal foam etc.), which is composed of an inexpensive material (metallic or not) (e.g., copper, brass, nickel, steel etc.), on the surface of which a continuous, thin layer of one or more different material (e.g., gold, platinum, silver, silver chloride, palladium, rhodium alloys of metals, carbon, graphene, conductive polymer) have been deposited. Three dimensional can be defined as a substrate that has a defined value of length, breadth/width, and depth/height above the nanoscale. Nanoscale can be defined as a scale where the measurement of a substance in any direction (x, y, or z) is between 0-100 nanometers (nm). The three-dimensional shape may be defined by the open celled formation of the substrate, e.g., where the material defines internal, and external, cavities that form empty spaces with generally arcuate cavity surfaces.

The continuous, thin electroactive layer can be deposited on the support structure using electrodeposition (e.g., for depositing metals and conductive polymers), chemical vapor deposition techniques (e.g., for depositing carbon nanotubes or graphene), or other chemical or physical deposition techniques (such as dip coating, sputtering, atomic layer deposition etc.). The electroactive surface of the fluid-permeable electrodes can be further modified to immobilize nanoparticles (e.g., noble metal nanoparticles), zeolites or other functional structures using electrodepositions, and other chemical and physical deposition techniques. The three-dimensional open cell geometry of the electrodes could be tailored by selecting the geometry of the three-dimensional support structure (such as wire diameter and mesh number for wire mesh electrodes, porosity for metal foam electrodes, metallic mesh, or screen of different types such as mesh or screen with rectangular, square, or any other shape of aperture; perforated metal sheet (with aligned or staggered perforations); expanded metal sheet, etc.).

The fluid-permeable, three-dimensional electrodes exhibit electrochemical properties that are typical to electrodes composed of the electroactive materials that are present on their surface. They also exhibit enhanced electrochemical properties (high electrocatalytic conversion rates, high electroanalytical signals) that are attributed to the geometry of the electrodes that allow a) high accessible surface per unit of mass of electrode material and per unit of projected area of the electrode, and b) high mass transport of chemicals/reagents onto the surface of the electrodes for electrodes physical and electrochemical characterizations).

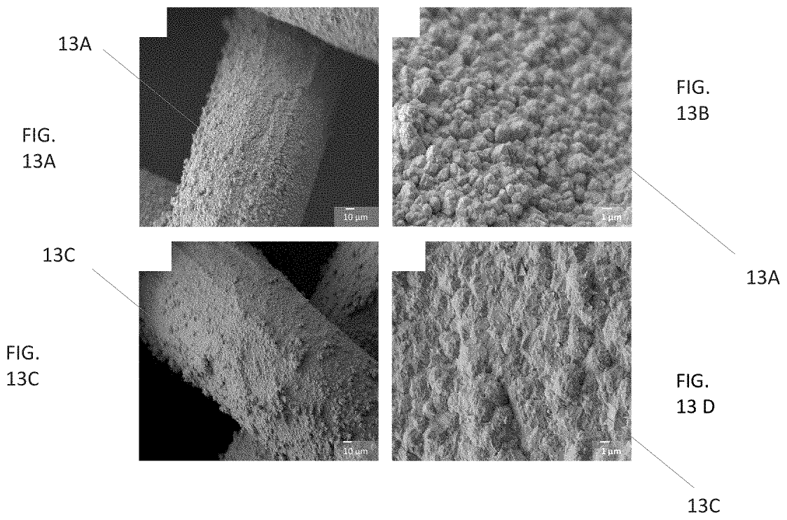

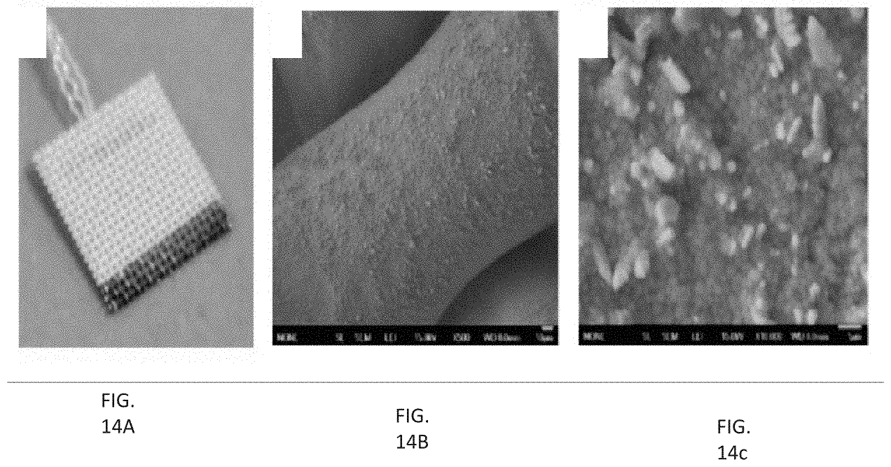

The three-dimensional, fluid-permeable electrodes could be fabricated at low cost because a) the electrodes may contain only a thin layer of an expensive electroactive material (e.g., gold, platinum etc.) on their surface while the main body of the electrode could be composed of an inexpensive metal (e.g., copper, brass, nickel, steel etc.), b) the geometry of the electrode is provided by the support structure that can be formed into the desired geometry using existing methods. The surface morphology of the continuous thin electroactive film on the surface of electrodes could also be tailored by tailoring the conditions of the deposition of the film on the support substrate. Like FIGS. 13A-13B where we see scanning electron micrographs of gold coating on a copper substrate that has ‘rock-like’ structure on the surface of the substrate when electroplated at −0.6 V vs. silver/silver chloride reference electrode, and FIGS. 13C-13D where we see a much flat surface when electrodeposited at −0.6 V vs. silver/silver chloride reference electrode.

FIG. 1H shows a beaker type electrochemical cell 2A within a beaker 2A-5. The cell 2A includes a first electrode 2A-10 which is a gold-plated fluid-permeable open cell electrode as a working electrode, which is one of the electrodes of FIGS. 1A-1I of the same configuration. A second electrode 2A-20 is an Ag/AgCl reference electrode. A third electrode 2A-30 is a platinum rod counter electrode, which is provided in a tube structure inserted within the beaker 2A-5. More specifically, the three-dimensional, fluid-permeable electrode in FIG. 1H can be used instead conventional electrodes in any conventional electrochemical cell (e.g., beaker-type electrochemical cells, small volumes electrochemical cells, H-type electrochemical cells, flow-cell).

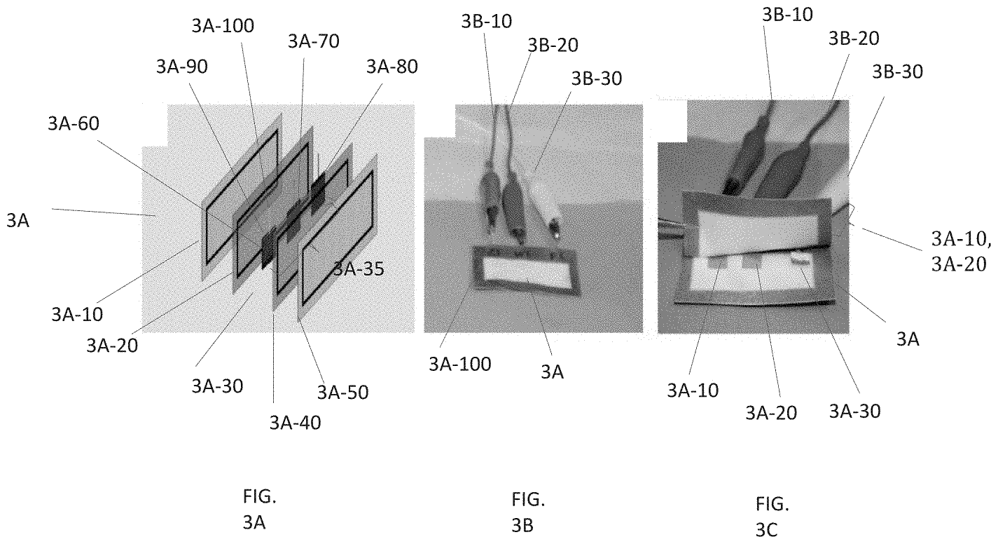

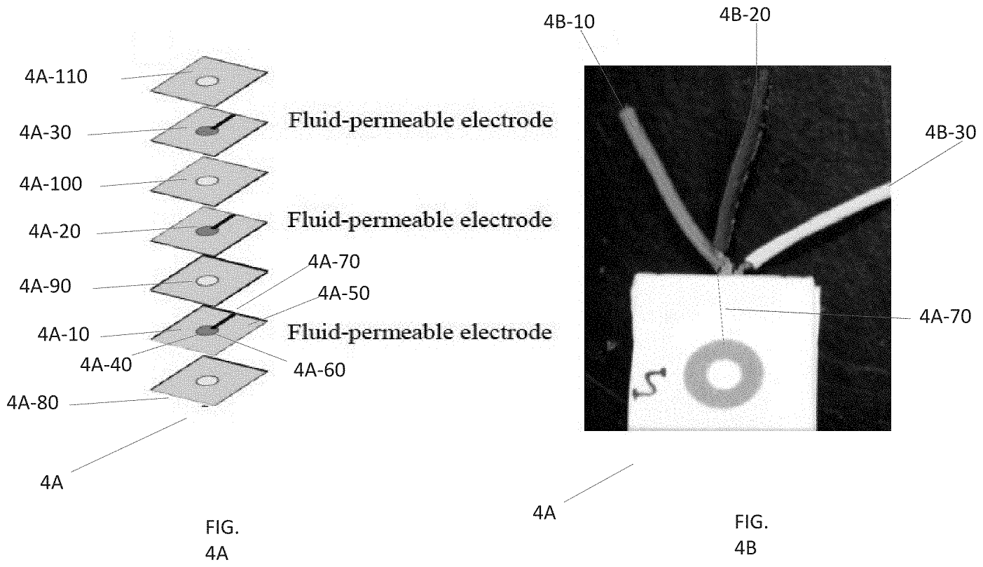

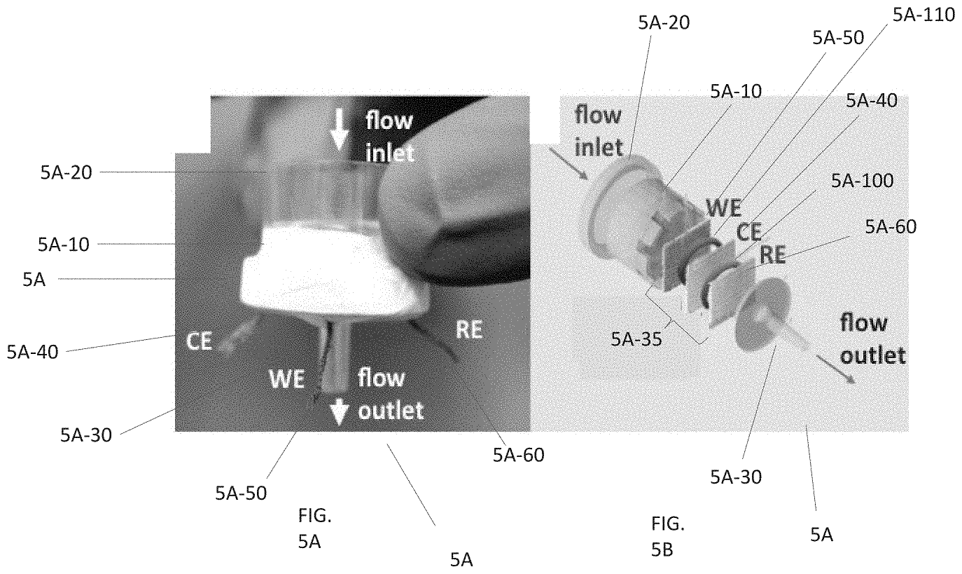

FIG. 2A shows examples of the use of fluid permeable electrodes in conventional beaker-type electrochemical cells. More specifically, the fluid permeable electrodes have been successfully used for the electrochemical detection of lead ions in water samples using anodic stripping voltammetry (FIG. 2A-2B), nitro compounds using cathodic differential pulse voltammetry (DPV) (FIG. 2C-2D), and the electrocatalytic oxidation of methanol (FIG. 2E). That is, FIG. 2A shows voltammograms of solutions of Pb2+ (0, 5, 10, 15, 20, 30, 40, 50 μg/L), 0.1 M PBS (pH 7) using an Ag wire-mesh electrode. The detection method utilized for obtaining the data in FIG. 2A is SWASV (V_{deposition}=−0.8 V vs. silver/silver chloride reference electrode, t_{deposition}=60 s, Vₛₜₑₚ=4 mV, SW amplitude=25 mV, SW frequency=15 Hz). FIG. 2B shows a linear calibration plot for Pb²⁺ ions detection. FIG. 2C shows voltammograms of samples containing different concentrations of nitrobenzene (0, 20, 30, 40, 50 μM) in 0.1 M PBS (pH 7) using Au wire-mesh electrode. The detection method utilized for obtaining the data of in FIG. 2C is DPV (V step 5 mV, step amplitude 25 mV). FIG. 2D shows a linear calibration plot for nitrobenzene detection. FIG. 2E shows cyclic voltammograms in the absence and presence of 1 M methanol in 0.5 M H₂SO₄ solution at a scan rate of 50 mV/s using a Pt wire-mesh electrode.

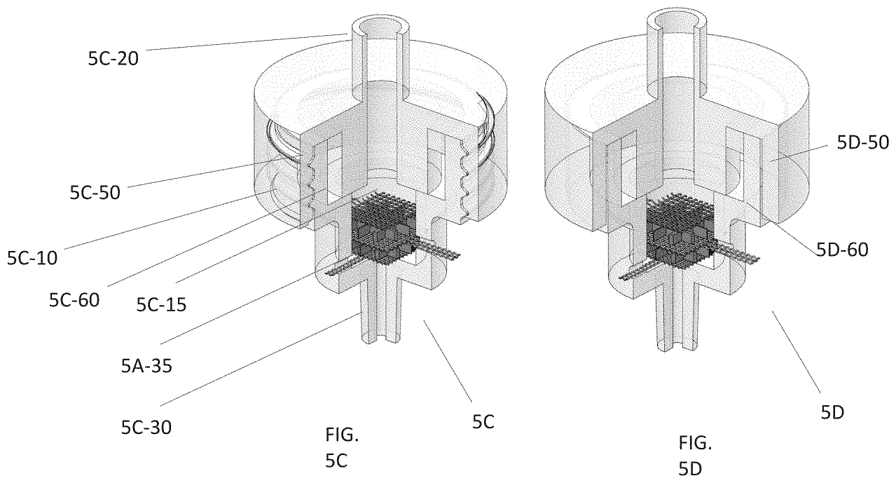

FIG. 3A shows a sensor 3A in an exploded view, which is a flexible, fluid-permeable electrochemical sensor for wearables. The sensor 3A is provided in a five-layer configuration, e.g., first through fifth layers 3A-10 to 3A-50. The five layers are configured as pairs (e.g., first and second pairs) of outer layers 3A-10 with 3A-20 and 3A-40 with 3A-50, and a center layer 3A-30. The outer layers may be layers of fabric, paper, plastic film with holes. The paper or fabric-based layers can absorb the sample (e.g., sweat) and through capillary forces guide it to pass through the electrodes. A combination of layers made of materials with different types of fiber structure (such as fabric, paper, chromatography paper, etc.) can be used for this purpose. The structure of the fabric or paper is sealed with a hydrophobic ink.

The center layer 3A-30 includes an electrode set 3A-35 defined by a plurality electrode, e.g., first, second and third electrodes 3A-60, 3A-70, 3A-80, which respectively are counter, working and reference electrodes. In the specified figure, we have a wearable sensor that contains three fluid permeable electrodes as counter electrode, working electrode, and pseudo silver-silver chloride fluid permeable reference electrode. The structure of the fabric or paper is sealed with a hydrophobic ink. Each of the electrodes includes an electrode body and lead. For example, the first electrode 3A-60 has first electrode body 3A-90 and first lead 3A-100.

FIG. 3B also shows the device 3A (e.g., a sensing device, or sensor) shown in FIG. 3A. That is, FIG. 3B shows an electrochemical cell in the form of a wearable, flexible, fluid-permeable electrochemical cell that can be used as a sensor. In the specified figure, we have a wearable sensor that contains stainless steel fluid permeable electrode as the counter electrode (FIG. 3A-10), gold fluid permeable electrode as the working electrode (FIG. 3A-20), and pseudo silver-silver chloride fluid permeable reference electrode (FIG. 3A-30). A plurality of external conductors, e.g., first, second and third external conductors 3B-10, 3B-20, 3B-30, are respectively connected to the electrode leads. For example, the first external conductor 3B-10 is connected to the first electrode lead 3A-100.

FIG. 3C also shows the sensor 3A. Specifically FIG. 3C shows an image of the electrochemical cell, with a pair of the outer layers (e.g., the first pair, 3A-10, 3A-20) pealed back to show the configuration of the electrodes 3A-10 to 3A-30 inside the cell 3A. The three external conductors 3B-10 to 3B-30 are also shown.

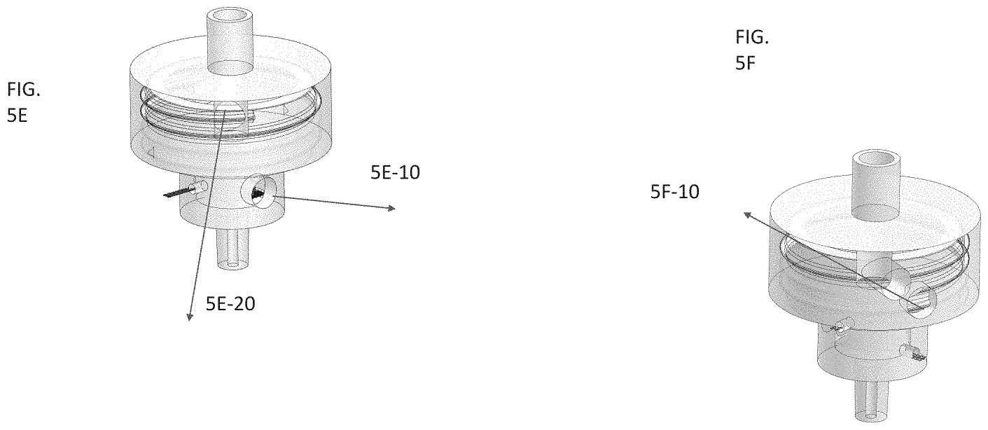

FIG. 4A shows a device 4A that is an example of a paper-based electrochemical device. The device 4A utilizes an electrode layer set defined by a plurality of electrode layers, e.g., first, second and third electrode layers, 4A-10, 4A-20, 4A-30, which are fluid permeable electrode layers. These electrode layers may each include an electrode, e.g., first electrode 4A-40 on first layer 4A-10 formed onto an electrode backing, e.g., first electrode backing 4A-50, which may be paper. These electrode layers may respectively define counter, working and reference electrode layers. Each electrode may define a body, such as a first body 4A-60 of first electrode 4A-10 which is shown as circular (though other shapes are within the scope of the disclosure), and an electrode lead, such as a first electrode lead 4A-70 of first electrode 4A-40. Paper may be layered, above, below and in between the electrode layers. Thus, there may be four layers of paper, 4A-80, 4A-90, 4A-100, 4A-110.

FIG. 4B shows an assembly view of the device 4A. A plurality of external electrodes, e.g., first, second and third external electrodes, 4B-10, 4B-20, 4B-30, are respectively connected to the three electrode leads. Thus, e.g., first external electrode 4B-10 is connected to first lead 4A-70 (shown schematically).

The electrodes' fluid-(liquid or gas) permeability also extends the applications of the electrodes in a) fluid-permeable electrochemical cells for air or liquid samples analysis, b) wearable paper-based or fabric-based sensors (such as sweat sensors) (FIGS. 3A-3C), and c) paper-based electrochemical devices (FIGS. 4A-4B). Fluid-permeable electrochemical cells are described in greater detail, below.

The wearable sensors that are provided by the disclosed embodiments are fabricated by using one or more fluid permeable electrodes (the type, dimensions and the electroactive material will depend on the target analyte) and layers of paper or fabric. All the layers including the fluid permeable electrodes are flexible and conformable, so the complete wearable sensor is also flexible. When in use, samples (such as sweat) and moisture can pass though the fabric of the wearable sensor and the electrodes so a target analyte could be detected in real time and continuously. The paper or fabric layers also ensure that all the electrodes are wet so the electrochemical circuit is closed, and the detection step can occur. FIGS. 3A-3C show an example of a wearable sensor that utilizes fluid permeable electrodes. The wearable electrochemical cell could be used for detection of electroactive analytes such as metabolites (e.g., glucose, lactate), enzymes, proteins, antibodies metals, biomolecules (e.g., dopamine, adrenaline, etc.), bacteria etc.

The wearable electrochemical cell can be placed on top of the skin.

The paper-based electrochemical devices that are provided by the disclosed embodiments contain one or more fluid permeable electrodes (the type, dimensions and the electroactive material will depend on the target analyte) and layers of paper. FIGS. 4A-4B show an image of an example of a paper-based electrochemical device that utilizes three fluid permeable electrodes. In comparison with the above-described paper-based electrochemical cells this paper-based electrochemical cells allow fluids to pass through the electrodes and there is enhanced mass transport of analytes and reagents to the surface of the electrodes. This sensor can detect electroactive analytes such as metabolites (e.g., glucose, lactate), enzymes, proteins, metals, metal ions, organic molecules, biomolecules (e.g., dopamine, adrenaline, etc.), pesticides, bacteria, organic pollutants

Design, fabrication, and applications of fluid-permeable, filter-like electrochemical cells (as used herein, filter-like means a planar or plate shaped structure that defines openings or apertures through which a gas or liquid may pass, permeate or flow-through).

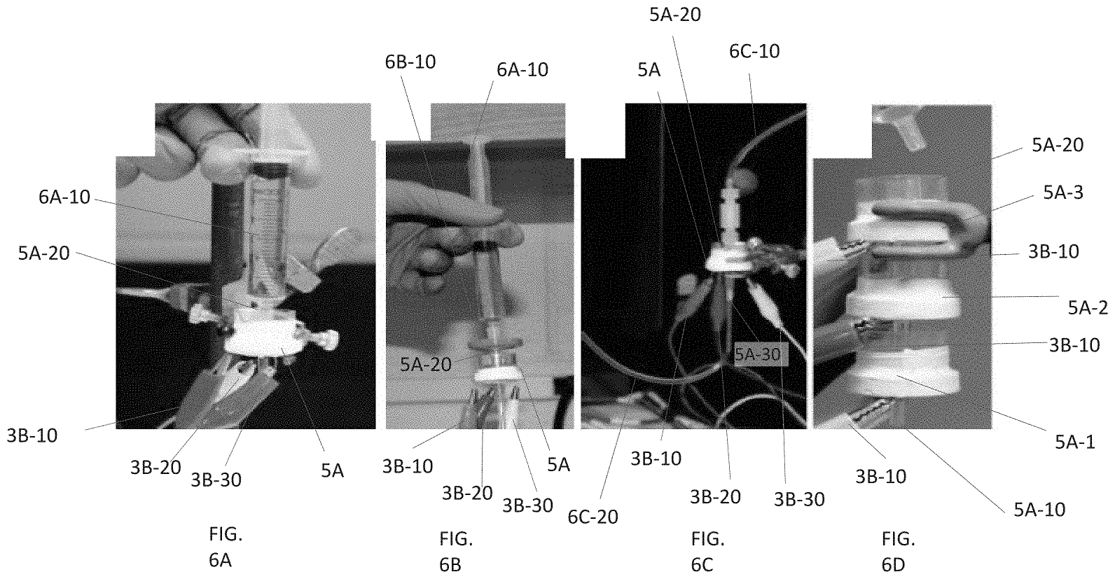

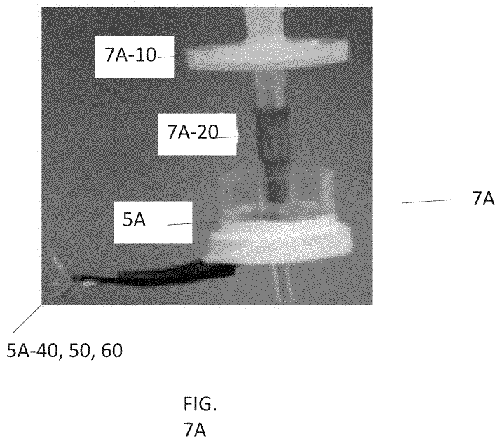

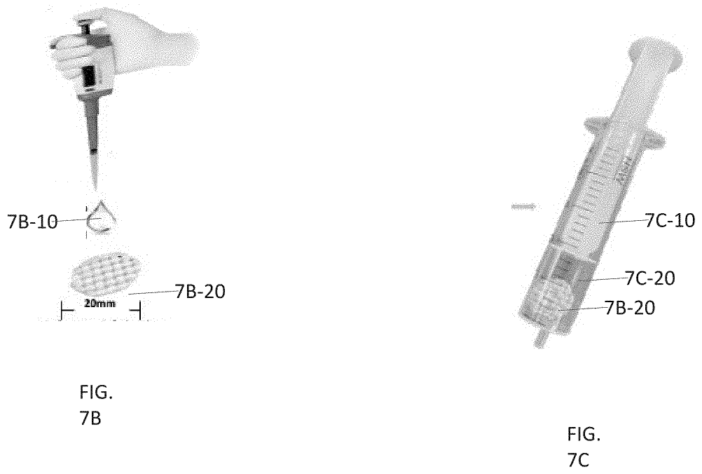

FIG. 5A shows an assembly view of cell 5A which is a fluid permeable electrochemical cell (or referred to as a fluid permeable ECC, or collectively referred to as an ECC). The cell 5A includes a body 5A-10 or compartment in the shape of a syringe filter. The body defines a chamber or housing with an inlet 5A-20 and an outlet 5A-30 spaced apart from the inlet. Between the inlet and outlet, an electrode set 5A-35 (FIG. 5B) is defined by plurality of electrodes, e.g., first, second and third electrodes, 5A-40, 5A-50, 5A-60 stacked within the housing. The three electrodes may respectively be counter, working and reference electrodes. Extending from the housing are a plurality of electrode leads, e.g., first, second and third electrode leads 5A-70, 5A-80, 5A-90, that are connected to, or integral with, respective ones of the electrodes. The electrodes may be selected from the electrodes of FIGS. 1A-1I or could be electrodes composed of carbon and or metal and have the shape of a wire, ring etc. That is, not all the electrodes should be necessarily fluid permeable. A wire electrode or a ring electrode can function as a counter or reference electrode. All fluid permeable electrodes (commercially available noble metal wire gauze, metallic foam, or electrodes that are fabricated using the above-described process can be used here).

Fabrication of Pseudo Silver-silver Chloride Reference Electrode.

Pseudo silver-silver chloride reference electrode is fabricated by converting a part of the silver electrode fluid permeable electrode (between 1-100%) by a process (e.g., electrochemical anodization, reaction with chloride containing reagents (bleach etc)). For example a pseudo silver-silver chloride reference electrode can be prepared by using a silver electrode in a three-electrode electrochemical cell, that contained 0.1M HCl as electrolyte, commercially available Pt/Ti as electrode as the counter electrode, commercially available Ag/AgCl electrode as a reference electrode. To anodize silver, a constant potential 50 mV above the open circuit potential (OCP) of the cell was applied for a duration of 30 min.

FIG. 5B shows an exploded view of the cell 5A showing the body 5A-10, inlet and outlet 5A-20, 5A-30. The body and inlet have similar diameters, and the outlet forms a sweeper-type nozzle with a wide nozzle base at its inlet side, substantially matching the diameter of the body 5A-10, and a narrow nozzle body and nozzle outlet or tip. Between adjacent ones of the electrodes in the set are spacing elements, including first and second spacing elements 5A-100 and 5A-110. The spacing material can be of any material that is electrically insulating, can be of any shape that permits the flow of the fluid through the device.

The disclosed embodiments provide an electrochemical cell (ECC); fluid-permeable electrochemical cell. Fluid-permeable electrochemical cells contain one or more fluid-permeable electrodes inside a compartment (made of plastic, glass, or metal) that has an inlet port and an outlet port, as indicated. Fluid-permeable electrochemical cells can operate in both static or flow conditions depending on the need, and they can utilize to analyze/treat both liquid and air samples/reagents. Fluid-permeable electrochemical cells can be operated using electrochemical analyzers (lab based or portable). FIGS. 5A-5B show an example of a fluid-permeable electrochemical cell that has the shape of a syringe filter and contains three fluid-permeable electrodes.

These fluid-permeable cells can be fabricated as shown in FIGS. 5A, 5B as the filter holders, or a cell can be designed as shown in FIGS. 5C-5D. Cell 5C includes a body 5C-10 defining a chamber 5C-15, an inlet portion 5C-20, an outlet portion 5C-30. The chamber 5C-15 houses the set of electrodes 5A-35 (FIG. 5A). The inlet portion 5C-20 and outlet portion 5C-30 may engage each other via respective inlet and outlet threaded sections 5C-50, 5C-60. FIG. 5D is a cell 5D having the same configuration of 5C except that inlet portion 5D-20 and outlet portion 5D-30 may frictionally engage via close-fitting cylindrical walls 5D-50, 5D-60. Thus, the holders can have a thread-like screw cap to assemble the two parts or have a snug top.

Turning to FIGS. 5E-5F, the holes (apertures) presented on the side and on the bottom of the holders are provided to hold a reference electrode. That is, the filter holders can also have an extra port to host an external electrode (such as a RE electrode or a counter electrode). For example, 5E-10, 5E-20, and 5F-10 represent a hole in the device for a commercially available reference electrode in the bottom of the device.

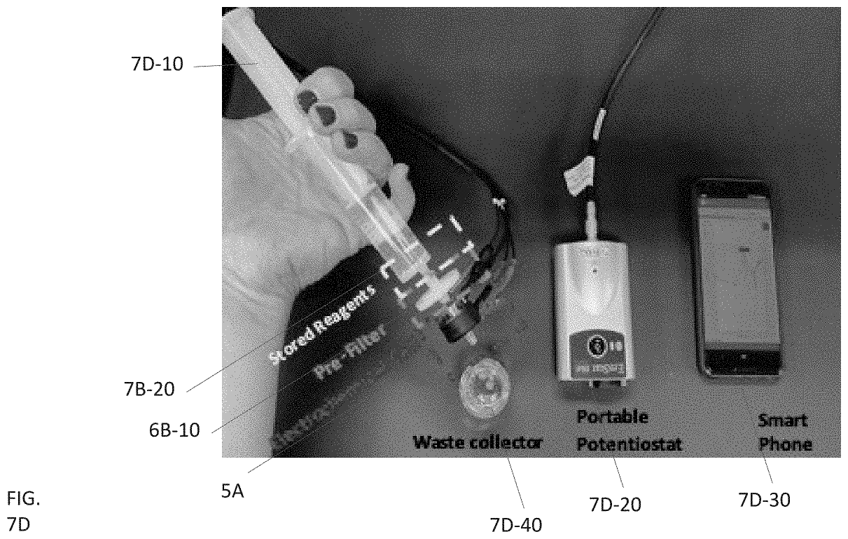

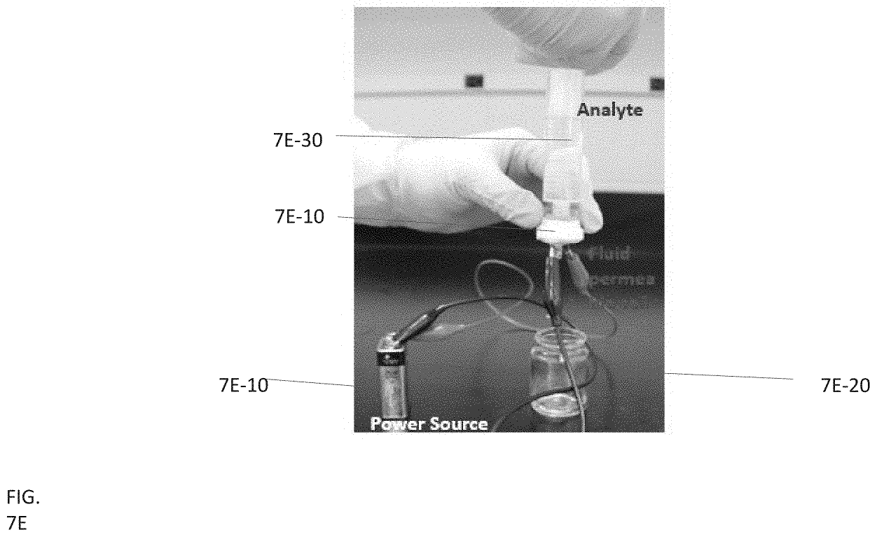

FIG. 6A shows the cell 5A (FIG. 5A) connected to a syringe 6A-10 via the cell inlet 5A-20 to deliver a sample. The first to third external conductors 3B-10 to 3B-30 (FIG. 3B) are respectively connected to the electrode leads of the cell 5A. FIG. 6B shows the cell 5A connected to the syringe 6A-10 by way of a syringe filter 6B-10 connected to the cell inlet 5A-20, to filter the sample while delivering the sample. The first to third external conductors 3B-10 to 3B-30 (FIG. 3B) are respectively connected to the electrode leads of the cell 5A. FIG. 6C shows the cell 5A connected to inlet and outlet tubes 6C-10, 6C-20 that are respectively connected to the cell inlet and outlet 5A-20, 5A-30 to allow the use of the electrochemical cell in flow-based systems. FIG. 6D shows a plurality of the cells 5A, identified as first, second and third cells, 5A1, 5A2, 5A3, connected in series, outlet to inlet, to form a system. The inlet 5A-20 of the topmost cell 5A-3 is the system inlet, and the outlet 5A-30 of the bottommost cell 5A-1 is the system outlet. Each of the cells is connected to external electrodes, e.g., electrode 3B-10.

Fluid-permeable electrochemical cells have been designed to drive fluids (gases or liquids) to pass through one or more of the fluid-permeable electrodes of the electrochemical cell to ensure high electrocatalytic conversion rates or high electroanalytical signals that derive from the increased interaction of the fluids with the fluid-permeable electrodes. The inlet and outlet ports of the fluid-permeable electrochemical cells allow loading of the samples or reagents inside the fluid-permeable electrochemical cell and also allow the fluid permeable cells to be readily connected to a) syringes and other sample delivery tools to deliver a sample (e.g., blood, environmental sample, etc.) to the cell (FIG. 6A) b) commercially available or costume made syringe filters or other compartments (that can perform functions such as the removal of interferences e.g., red blood cells, dirt, particulates, proteins etc., or to host necessary reagents for the electrochemical system (FIG. 6B), c) tubes to facilitate flow-based in-line electrochemical systems (FIG. 6C), or d) other fluid-permeable electrochemical cells to facilitate electrochemical systems that need stacks of fluid-permeable cells (FIG. 6D).

The embodiment in FIG. 6D can be used to detect more than one analyte in a sample because one or more can be detected in each electrochemical cell. That is each cell would have a different set of electrodes, respectively configured to detect different analytes (biomolecule, metabolite, an enzyme, a protein, an antibody, a metal, metallic ions, bacteria, pesticides, or an organic pollutant or organic compounds).

The embodiment of FIG. 6C (and 6D as well) can be utilized as an electrochemical detection flow cell, connected in series with a tubing, that is connected to a pump (peristatic) on the upstream or downstream side of the flow cell, which is connected to a solution reservoir on the upstream side of the flow cell. The fluid is ultimately (downstream) directed to a waste drain or reservoir via tubing. The flow cell can detect analytes as indicated above. The leads of the electrodes in each instance is connected (via a wired connection as an example) to a potentiostat (electrochemical analyzer), which is connected (via a wireless connection as an example) to a display output such as a smart device.

Fluid permeable electrochemical cells are distinctly different from conventional electrochemical cells (beaker-type electrochemical cells, small volumes electrochemical cells, H-type electrochemical cells, screen printed electrochemical cells) because of their design, shape, and use of fluid permeable electrodes that exhibit high accessible surface per unit of mass of electrode material and per unit of projected area of the electrode. Fluid permeable electrochemical cells are also distinctly different than conventional flow electrochemical cells (e.g., thin layer electrochemical flow cells, flow cells that host screen printed electrodes, or flow cell design used in flow batteries or fuel cells) because a) their unique design, b) they drive the fluids to pass through one or more fluid permeable electrodes; on contrary conventional designs of flow electrochemical cells drive fluids on top of planar electrodes, c) they can be readily connected to other laboratory tools (tubing, syringes, syringe filters etc.).

Fluid-permeable electrochemical cells can be used in electroanalysis (to detect metals, metal ions, pesticides, enzymes, organic molecules, biomolecules, proteins, bacteria, cells, virus, nucleic acids among others etc.), electrocatalysis (electrocatalytic conversions), water and or waste treatments (to kill/decompose contaminants such as bacteria, virus, pesticides). Examples of uses of fluid-permeable electrochemical cells in a) electroanalysis (detection of redox mediators, hazardous heavy metal ions, bacteria, and vapors of polar compounds (amino-, nitro-, and hydroxyl-compounds etc.), b) electrocatalysis to allow water treatment (decontamination of water from contaminants such as bacteria), c) electrocatalysis for waste treatments (e.g., decontamination of wastes that contain bacteria).

Design, Fabrication, and Applications of Fully Integrated, Fluid-Permeable Analytical Devices for in Field Chemical and Biochemical Analysis.

The disclosed embodiments provide the design and fabrication of fully integrated, fluid-permeable analytical devices for the detection of analytes (e.g., hazardous metals, volatile organic compounds, small molecules, proteins, bacteria, nucleic acids, or other analytes) in liquid or air samples in the field using (inventors, the use of “simple” may be a problem if we are not more specific) analytical protocols. The fully integrated, fluid permeable analytical devices contain: a) one or more fluid-permeable/flow cells (fluid-permeable electrochemical cell described above, electrochemical flow cell that host screen printed electrodes, flow cell for photometric analysis, etc.) that would perform the detection step of the analytical protocol, and b) one or more of the followings: syringe filters or other filters for sample filtering or removal of interferents, compartments (composed of plastic, glass or metal) that would have the necessary reagents of the assays prestored inside them in dry or liquid form, compartments (composed of plastic, metal or glass) for reagents mixing, incubations etc. The different parts of the device would be readily connected to each other as they would incorporate standard fittings (e.g., Female Luer Lock Inlet, Male Luer Slip Outlet etc.). The overall operation of the devices could be as simple as passing a sample through a filter (the device in this case) with a syringe. If necessary, the user may need to attach or detach parts of the device in a plug-and-play fashion to complete the assay. A portable electrochemical analyzer (it could be even a small, battery-powered one) performs the electrochemical analysis (automatically or after user input) and transmits the results to another device such as a cell-phone or a laptop etc.

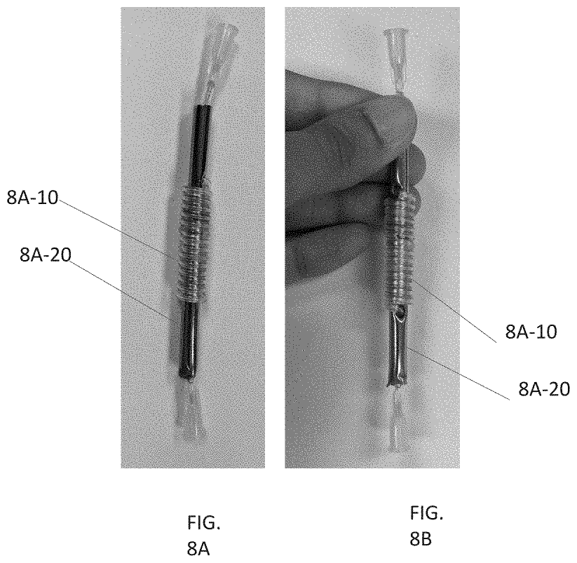

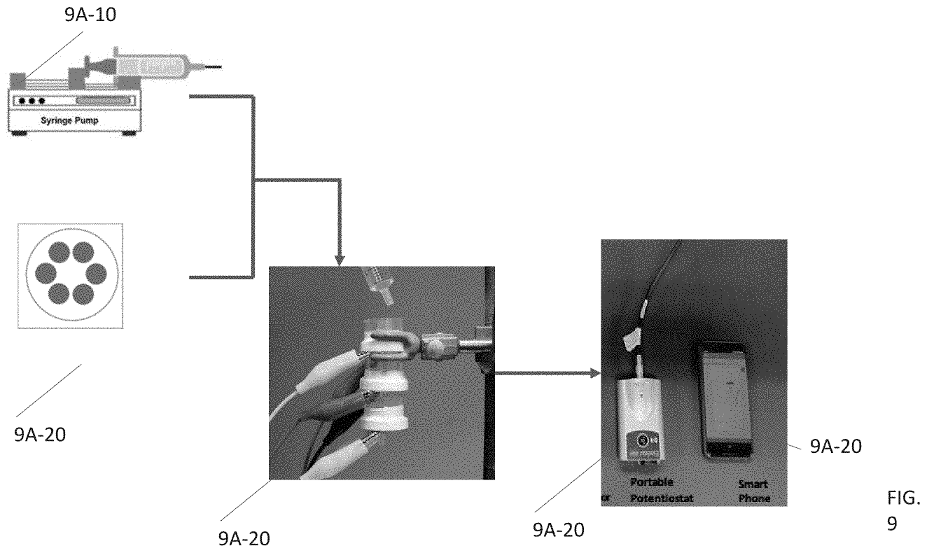

FIG. 7A shows a device 7A (which may also be referred as a sensor or sensing device) that is an integrated, fluid permeable electrochemical device for the detection of hazardous metals in water samples. The device 7A utilizes a syringe-filter 7A-10 for in-line sample filtering. A plastic cell 7A-20 is provided that is a reagent delivery implement (or tube) that has reagents prestored (buffer solutions, extra reagents, etc.), and the fluid-permeable electrochemical cell 5A (FIG. 5A) that is configured to perform the electrochemical detection, utilizing electrode leads 5A-40 to 5A-60. For example, the sensor 7A may be connected to a portable electrochemical analyzer to perform the analysis, e.g., an analyzer known by the trade name EmStat3, a potentiostat with a potential range of +/3V or +/4V, and a current range of 1 nA to 10 mA or 100 m, available at https://www.palmsens.com/product/emstat/.

The fully integrated, fluid permeable analytical devices demonstrate the following important advantages compared to other analytical devices. (a) They do not necessarily require pumps for fluidic flow; the samples could be delivered and pushed through the cell using a syringe. (b) They do not require manual addition of reagents; the necessary reagents for analysis are prestored inside the sealed fluid-permeable/flow cell (or other compartments that could be readily connected to the cell) to be released only when the fluid passes through the cell. (c) They can analyze untreated samples because they can remove interferents in line using syringe filters or other filtering tools. (d) They could allow multiplex detection of analytes; multiple fluid-permeable/flow cells could be connected in series to detect several analytes in a single sample. (f) They exhibit unmatched sensitivity especially when the assays require the preconcentration of the analyte and fluid permeable electrochemical cells are used because fluid permeable electrodes allow the maximum possible interaction between the sample and the electrodes that could greatly facilitate the preconcentration of analyte on the electrode. (g) They are capable of transmitting the results to cell-phones in an automated way; the portable electrochemical readers can perform the electrochemical assay and send the results without user involvement.

The disclosed embodiments provide a number of examples of fully integrated, fluid permeable analytical devices for the detection of a) hazardous metals in water samples and blood using anodic stripping voltammetry, b) bacteria in urine using impedance spectroscopy, c) bacteria in water, juices, and other food products using immunoassays or photometric assays, d) volatile organic compounds in air samples or food samples. FIG. 7 shows a fully integrated, fluid permeable device for the detection of hazardous metals in water samples.

Point-of-Need Electrochemical Detection of Lead in Tap Water Using the Flow-Through Electrochemical Cell.

FIG. 7B FIG. 7B shows reagents 7B-10 which have been deposited onto a piece of paper or fabric (e.g., polyester) 7B-20 and let dry to form a reagent disk (or reagent delivery disk or reagent wafer). The reagent may be 400 microliters HNO3 and 1 M NaCl in water. The reagent delivery disk may be 20 mm in diameter. FIG. 7C shows the reagent disk within a syringe 7C-10 (which may be similar to syringe 6A-10). A sample, e.g., in solution 7C-20 is also in the syringe. The reagents will be dissolved while being exposed to temperatures of 100 C for 30 minutes and will mix with the sample. FIG. 7D shows the syringe, with the reagents dissolved in solution, during a test of the sample. The solution is pumped via action of the syringe plunger 7D-10 into cell 5A. A filter such as filter 6B-10 may be provided between the syringe output and input of the cell 5A. The electrode set 5A-35 (FIG. 5B) is electrically connected (e.g., via a wired connection) to a portable potentiostat 7D-20, which may be wirelessly connected to a smart device 7D-30, such as a mobile phone, to generate data from the test using known methods. A waste cup 7D-40 may collect waste from the output of the cell 5A. The smart device may be a computer, a controller, a mobile phone, or other electronic device.

Necessary reagents for the assay can be stored in a piece of fabric. Fabric pieces can be cut in the desired dimension and on top of them, liquid reagents, analytes, molecules of the desired compound can be added and dried to store in the reagents for long term, portable use.

FIG. 7E is an alternative to the configuration of FIG. 7D in which the ECC 5A is powered by a battery 7E-10 or power source for other applications such as decontamination of liquid sample containing bacteria etc. The liquid flows to the ECC from the syringe under mechanical pressure, where it is decontaminated, and then flows into a collection cup 7E-20. For example, the contaminated liquid may be water+bacteria and the decontaminated liquid may be water+minimal bacteria. Alternatively in place of the syringe, an input tubing connected to a fluid reservoir via a pump may be utilized to transfer fluid stored in bulk to the cell for a continued decontamination (see FIG. 6C).

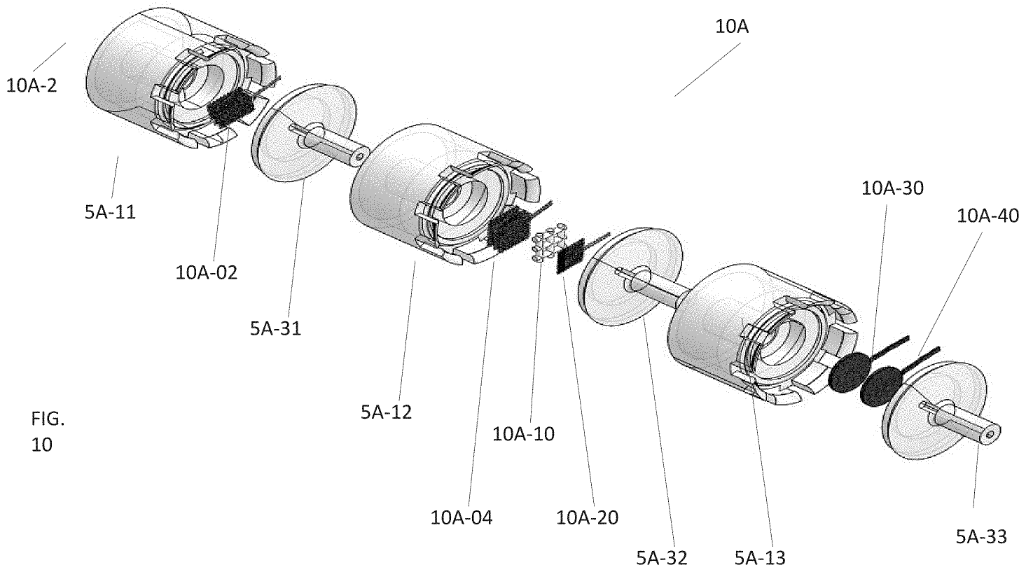

FIGS. 8A and 8B show a flow a controlling device. Tubing 8A-10 is wound around a cylindrical device 8A-20 and the flow rate of the solution exiting the device is a function of the diameter of the tubing, number of turns the tubing is wound around the cylinder, and the diameter of the cylinder.

That is, a flow controlling device is shown to eliminate the need for a pump to control flow rate. This device is fabricated by wrapping a tube of a certain diameter around a cylinder (of any material like plastic, metal, wood, etc.) of a certain diameter. The number of turns that the wire makes around the cylinder, along with the diameter of the tube, and diameter of the cylinder on which the tubing is held helps decide the flowrate. The inlet and the outlet of this device can be connected to any of the filters, syringes, needles, electrochemical device, etc. using the correct connections and adapters (FIGS. 8A and 8B).

Fluid Permeable Electrochemical Device for the Detection of Polar Organic Compounds in Breath and Air.

Zeolites (like ZSM-5 aluminosilicate zeolite, etc.) have high surface area and can trap polar compounds inside their structures. Zeolites can trap significantly higher amount of polar vapors (aniline, phenol, nitrobenzene) than unmodified electrodes. Fluid-permeable electrodes can be functionalized with zeolites to trap highest amount of polar organic vapor from compounds that can be used to for the fabrication of filter-like ECCs for breath analysis. The measurement of endogenous volatile organic compounds (VOCs) in exhaled breath has a significant diagnostic value as they reflect individual metabolic and inflammatory conditions. For example, the concentration of alcohols (e.g., ethanol, 1-propanol) and aldehydes (e.g., heptanal, hexanal, formaldehyde, etc.) in breath has been correlated with lung cancer. Fluid permeable electrochemical sensor can detect different types of polar organic compounds (alcohols, aldehydes, etc.) in breath. Fluid permeable electrochemical sensor use a Fluid permeable electrochemical sensor ECCs (e.g., as shown in the above FIGS.) with a zeolite functionalized fluid-permeable WE (working electrode) electrode and a salt electrolyte prestored. The user blow air through the sensor (to allow trapping of polar volatile compounds on the surface of zeolite functionalized electrodes) and then add few drops of a reagent liquid to the cell to perform the electrochemical detection (e.g., differential pulse voltammetry). A device as shown in FIG. 5, or other device (even beaker, H-cell) that can be used with fluid permeable electrodes can be applicable here.

Detection of VOC Using Flow Through Electrodes.

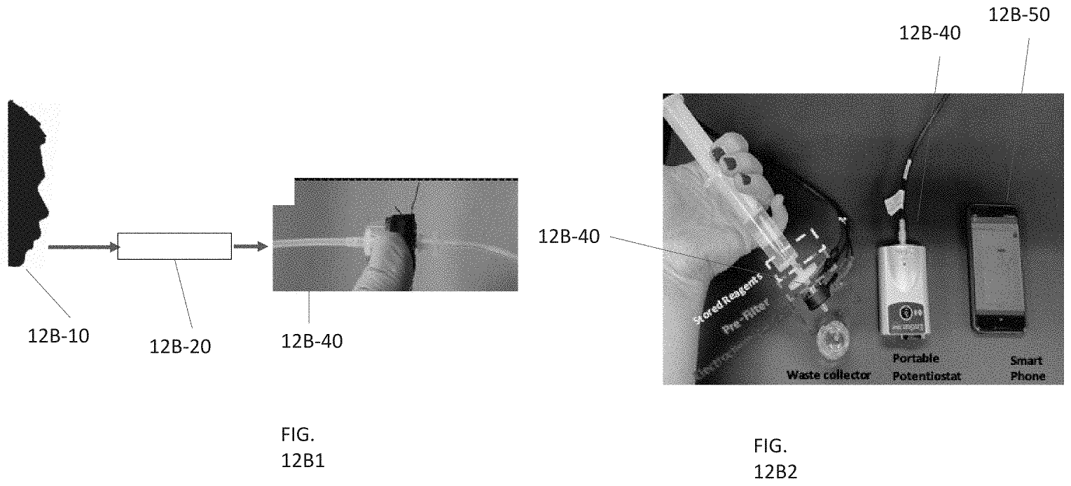

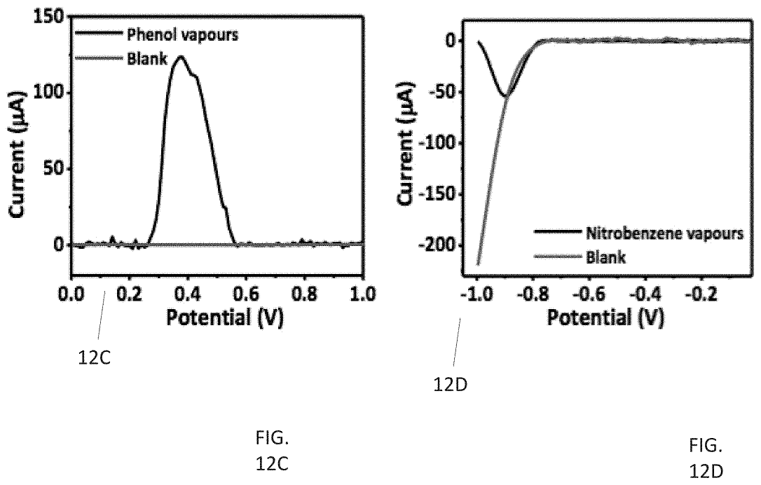

Turning ahead to FIGS. 12A1 and 12A2, to detect volatile organic compounds (VOCs), a fluid-permeable electrochemical cell will be connected to a gas sampling pump. The small, portable, calibrated, hand-held gas sampling pump will pass the air sample from the concerned area to the fluid-permeable electrochemical cell for a short period of time. After that, a solution containing buffers and electrolytes from a container kit or pre-stored in a syringe or other device will be passed through the fluid-permeable (or filter-like) electrochemical cell(s). The leads of the Fluid permeable electrochemical sensor will be connected to a potentiostat and using SWASV, DPV, or other electrochemical technique, the sample of the gas will be analyzed for VOCs. That is, an air sampling source 12A-10, in fluid communication with a pump 12A-20 via a tube or conduit, transfers air to a filter 12A-30 to trap moisture and contaminants. Then the filtered air continues via the tube or conduit to the ECC 12A-40 configured similarly to FIG. 7D, which utilizes the potentiostat 12A-50 and cellular device 12A-60 as indicated above. Then (FIG. 12A2) the conduit is detached from the cell after the air has been received by the cell, and the syringe is attached to provide a reagent in solution to be receive by the cell, during which electrical signals is measured by the potentiostat as indicated for display on the cellular device.

Breath Analysis

Turning to FIGS. 12B1 and 12B2, to analyze breath of the breathing subject, the subject will exhale directly into the electrochemical cell that is being used as a sensor. This cell can be fabricated using any of the above-described substrates (mesh, foam, ring, wire, metal screen, etc.) and with any electroactive material necessary for the application. The sample can be collected with or without a hose/fitting/collection device. A filter/membrane/a device to absorb/adsorb moisture from the breath can be attached to the inlet of the electrochemical cell/device. Once the air has passed the electrochemical cell/device for a certain amount of time, a solution containing buffers and electrolytes from a container kit or pre-stored in a syringe or any other device will be passed through the fluid-permeable (or filter-like) electrochemical cell(s). The leads of the Fluid permeable electrochemical sensor/electrochemical cells will be connected to a potentiostat and using SWASV, DPV, or any other electrochemical technique, the sample of the gas will be analyzed for compounds. That is, first (FIG. 12B1) a person 12B-10 breaths into to a tube or conduit directed to a filter 12B-20 to trap moisture and contaminants. Then the filtered air continues, due to pressure from the breath to the ECC 12B-40 configured similarly to FIG. 7D, which utilizes the potentiostat 12A-50 and cellular device 12A-60 as indicated above. Then (FIG. 12B2) the conduit is detached from the cell after the air has been received by the cell, and the syringe is attached to provide a regent in solution to be receive by the cell, during which electrical signal data is measured by the potentiostat as indicated for display on the cellular device.

For gas sensing (breath or pump supplied), turning to FIG. 12C, the WE may be obtained via chemical vapor deposition (CVD) of graphene or may be Au fluid-permeable electrode (functionalized with nanocrystalline ZSM-5 aluminosilicate zeolite). The graphical readout on the mobile device is shown in FIGS. 12C and 12D, respectively in graphs 12C and 12D, which show a level of phenol or nitrobenzene in air sample that may be collected as an environmental sample or breath or both. These readout show high intensity of the current response (or signal) for lower concentration of the analyte (e.g., nitrobenzene, aniline, phenol, etc.).

Development of Fully Integrated Filter-Like Compartments That Would Allow Filter-Like Electrochemical Sensors to Perform In-Line Filtering, Reagents Mixing Seamlessly.

Filter-like electrochemical sensors can be fully integrated and can be engineered to perform in-line filtering, in-line reagent addition and multistep detection assays seamlessly. In-line filtration of biofluids, especially blood samples, to remove red blood cells or proteins should be performed. Given that typical syringe filters do not perform blood plasma separation, several syringe filters can be fabricated that would incorporate various materials (e.g., polymeric membranes, blood separation membranes, salt functionalized paper, and/or use other designs (e.g., micro/mesoscale sedimentation chambers). Following this fabrication, the filters are integrated with filter-like compartments that contain chemical reagents to form a fully functional electrochemical sensor for detection of heavy metals, pollutants, pesticides, biomolecules, antibodies, antigens, proteins, nucleic acids, bacteria, biomarkers in urine, serum, plasma, environmental water, drinking water, food extracts, liquid beverage, liquid food sample, and whole blood.

Develop Fluid-Permeable Electrochemical Sensors for the Detection of Total Load of Bacteria in Urine or Other Samples.

Fluid permeable electrochemical sensor may give superior sensitivity than other electrochemical cells because while a sample flows inside fluid permeable electrochemical cells and through flow-permeable electrodes, the whole body of the sample (and the total number of bacteria) is forced to be in very close proximity to the surface of the electrodes (less than 50 μm). When fluid-permeable electrodes are functionalized with captured antibodies or other biomolecules, then bacteria are captured while pass through the fluid permeable electrodes. For example, traveling over a surface 20A-10 of the gold functionalized electrode (FIG. 20). In this instance, functionalization is related to the immobilizing, on the electrode, a complex 20A-30 that has thiol- and biotin-biofunctionalized DNA, avidin and the biotinylated antibodies against bacteria or specific aptamers. Due to this, a large number of bacteria 20A-20 is captured by the electrodes. Polyaniline electrodes is also functionalized by activating the electrode with carbonyldiimidazole and then immobilize on it antibodies or aptamers. A device as shown in FIG. 5, or other device (a beaker, or H-cell) that can be used with fluid permeable electrodes can be applicable here.

The fluid permeable electrochemical sensor performs in-line capture of bacteria and detection with any electroanalytical technique (amperometric, potentiometric or voltametric) such as impedance spectroscopy, differential pulse voltammetry, square wave voltammetry, linear pulse voltammetry etc.) connected to the electrode leads. A device as shown in FIG. 5, or other device (e.g., a beaker, or H-cell) that can be used with fluid permeable electrodes can be applicable here.

Fluid Permeable Electrochemical Sensor That Host Electrodes Modified with Aptamers for Chemical and Biochemical Analysis.

Fluid-permeable electrochemical cells can be used to fabricate aptamer-based electrochemical sensors for detection of analytes (biomolecule, a metabolite, an enzyme, a protein, antibodies, a metal, metal ions, bacteria, DNA, RNA, vector, or organic pollutants, pesticides, volatile compounds) in biological and environmental samples (blood, urine, environmental water, breath, atmospheric air). Aptamers can be immobilized on the surface of fluid-permeable electrodes. When the analyte does not interact with the aptamer the electroanalytical signal is low but when it interacts signal increases.

Detection of Metals and Metal Ions in Liquid Samples.

To analyze liquid samples (e.g., environmental water, drinking water, food extracts, beverages, liquid food samples, etc.) and/or biological samples such as whole blood, serum, urine, plasma to determine the concentration of metals and metal ions such as lead, cadmium, arsenic, mercury, copper, chromium, zinc etc., the sample can be passed through the electrochemical cell which utilizes fluid-permeable electrodes and detecting using a potentiostat which applies a technique such as SWASV, DPV, etc. To pass the solution through the electrochemical cell, a syringe and/or a tube can be used. The syringe and/or tube can contain pre-stored reagents that have been dried on top of a fabric, paper, etc. (FIG. 7B). The pre-stored reagents can be buffers, electrolytes, or other supporting solution for successful completion of the analysis. The solution can be passed through the electrochemical cell using a syringe pump, hand, peristaltic pump, or other device that can pass the solution through the cell (FIG. 7C).

The electrochemical cell means a complete assembly of WE, CE, and RE. The electrochemical cell may consist of one filter-holder that has all three elements of a cell or more than one filter holder or other system that utilizes 3-D, fluid-permeable electrodes. The electroactive material covering the surface of the substrate could be noble metal (like gold, silver, platinum, etc.), nanomaterials (like gold nanoparticles), other metal (like palladium, rhodium, titanium, etc.), conductive polymers (like PEDOT etc.) or graphene, carbon nanotubes, other carbon materials.

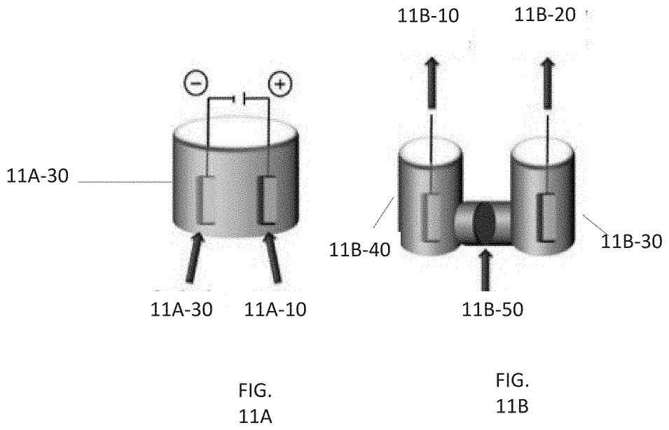

Turning back to FIG. 9, the figure shows a configuration in which where one or more devices can be connected to a system that pumps solution through them like a syringe pump 9A-10 or a peristaltic pump 9A-20. Once the solution passes through the fluid permeable device 9A-30 (shown as the device of FIG. 6D, for example), the analysis is done using a portable or a benchtop potentiostat 9A-20 and the readout is seen on a cellphone 9A-30 or a computer screen.

Decontamination of Water and Biological Waste

FIG. 10 shows the exploded view of a single electrochemical device that is a combination of three flow-through devices each containing a single or multiple electrodes as deemed necessary for the application. The figure shows an inlet 10A of a flow-through device. A spacing element 10A-10 is shown that is in the form of a mesh that can be made of any electrically insulating device. Metallic foam electrodes 10A-30 and 10A-40 are shown, which in this specific example are coated with platinum metal. A fluid-permeable pseudo silver/silver chloride reference electrode 10A-20 is shown, which may be electrode 1E, above. A stainless-steel flow through counter electrode 10A-02 and 10A-04 are shown that is folded multiple times.

That is, FIG. 10 shows a device 10A, which is a filter-like electrochemical device to decontaminate water and biological samples. The device 10A is defined has a device inlet end 10A-2 and a device outlet end 10A-4. Between the inlet and outlet ends are a plurality of the body members 5A-11, 5A-12, 5A-13 that are housings similar to the body member 5A-10, e.g., such that they are cylindrical and configured serially from end to end so that the first body member is at the inlet end of the device 10A and the third body member is at the outlet of the device 10A. Each includes a respective one of the inlets 5A-31, 5A-32, 5A-33 which are the same as inlet 5A-30. The first body member houses a first electrode 10A-02 and the second body member houses a second electrode 10A-04, identified above.

Fluid-permeable electrochemical cells can be used to decontaminate water (portable, tap water, or wastewater etc.) and biological waste (such as biological samples from laboratories, clinics etc.) containing bacteria and viruses. FIG. 10 shows a setup that can be used to decontaminate the sample. By adding a small amount of disinfectant in the waste sample (like H2O2) (e.g., in a fluid supply reservoir or inline via tubing) and passing the sample through the fluid permeable electrochemical cells and applying a small potential (such as the one of FIG. 10) the pathogens can be killed completely. The pathogens are killed because when the disinfectant interacts with the fluid permeable electrodes radical species (e.g., reactive oxygen species etc.) are produced, and these radicals kills/denaturate the pathogens

Use of Fluid Permeable Electrodes and Electrochemical Cells for Catalytic Conversions (Such as CO₂ Reduction) and Electrosynthesis.

Fluid-permeable electrodes can be used to make an electrochemical cell in a beaker, H-cell, filter-like cell, or other conventional electrochemical cell setup. This cell can be used for catalytic conversion of reagents (such as CO₂) or electrosynthesis (perform reduction or oxidation reactions, polymerizations) in aqueous phase or organic to other useful products. The electrodes can consist of any of the substrate discussed in the above disclosure. The electrodes facilitate these reactions by providing highly reactive reaction centers for the reaction to proceed towards the production of products by reducing the activation energy required for the reaction. To facilitate the reaction, power is provided to the electrodes, such as by a battery or other power source.

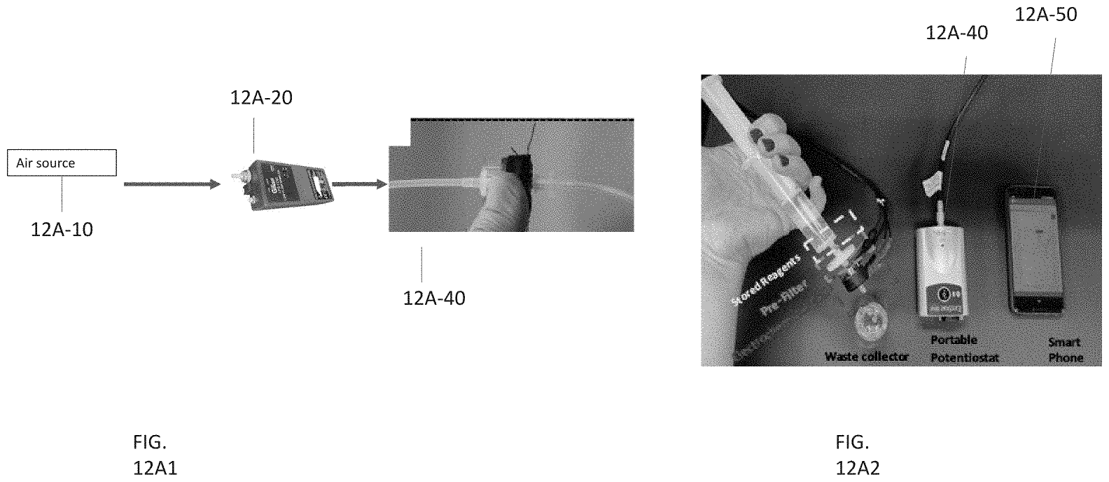

Turning to FIG. 11A, the figure is a schematic diagram of an undivided electrochemical cell. FIG. 11A shows an anode 11A-10 and cathode 11A-20 entering a container 11A-30 FIG. 11B is a schematic diagram of a divided electrochemical cell. FIG. 11B shows a working electrode 11B-10 and an auxiliary electrode 11B-20 exiting separate segments 11B-30, 11B-40 of a divided container 11B-40 with a cell separator 11B-50 therebetween. The configurations of FIGS. 11A and 11B can be used for CO2 reduction and electro synthesis.

Fluid-permeable electrodes can be used as high surface area, highly-reactive, robust electrodes for electrochemical organic synthesis in a conventional setup as shown in FIGS. 11A and 11B. They can also be used to fabricate fluid-permeable electrochemical cells that are different than the ones shown in above figure.

With reference to the electrodes shown in FIGS. 1A-1I, FIGS. 13A-13D show SEM (scanning electron microscope) images of Cu wire mesh (with three leads) plated at different potentials vs. Ag/AgCl reference electrode. FIGS. 13A-13B show −0.6 V, with ‘rock-like’ crystal structure 13A at 10 and 1 micrometers, respectively. FIGS. 13C-13D show −0.9 V, with a relatively flatter crystal structure 12C as compared to structure plated at −0.6 V, at 10 and 1 micrometer, respectively. With modifications to the deposition conditions and procedures, different structures (like nanoparticles, nanorods, nanoflowers) on the surface of the electrode.

The above embodiments show the versatility and the modularity of the fluid permeable cell 5A. The cell 5A can be directly connected to various commercially available components. The cell 5A can be directly connected to (a) a syringe, (b) a filter that in turn can be connected to another syringe or a tube or a fluid permeable cell or all, (c) various adapters that can be connected to a tube of in-line use to detect bacteria in urine, heavy metal detection and all other listed applications, and (d) is modular that means many cells) can be connected in series in various combinations of the order of electrodes for the application of need.

In addition, the following disclosure is related to the disclosed embodiments.

Examples of Fabrication of Fluid Permeable Electrodes

Fabrication of Au Fluid Permeable Electrodes.

Wire mesh and metallic foam Au electrodes of various geometries (wire diameter, mesh number) were prepared using a electroplating process (that may or may not need ultrasonication). In brief, gold bath was placed in a water bath maintained at a elevated temperature between (e.g., 60-62° C.) on a hot plate with a magnetic stirrer. The optimum conditions for this bath was 60° C. with mild agitation. After the bath reached optimum temperature, the electrochemical cell was set up as a three-electrode system with the copper mesh/foam as working electrode, a commercial Ag/AgCl reference electrode and a commercial mesh-type platinized titanium electrode. The reference electrode and the counter electrode were placed in the bath and the current in the cell was switched on.

When sonication was needed, the working electrode (copper mesh/foam substrate) was tied to the tip of the probe type sonicator, near the end, and then dipped in the beaker to complete the electrochemical cell and the electric circuit. The potential at the working electrode was set between −0.6 to −0.9 V. The sonicator was switched on, to provide pulses of ultrasound waves that created waves in the solution, which in turn vibrated the mesh during the plating process.

After plating the mesh/foam for the time necessary to obtain a thickness of at least 1 μm (the plating time was influenced by the applied potential), the plated mesh was washed with deionized water. Then, the plated mesh was taken out, dried in air and stored under vacuum. More information about the fabrication of gold electrodes could be found on the attached manuscript and attached MSc thesis.

Fabrication of Ag Fluid Permeable Electrodes.

Wire mesh and metallic foam Ag electrodes of various geometries (wire diameter, mesh number) were prepared using a electroplating process (that may or may not need ultrasonication). In brief, silver bath was placed in a water bath maintained at room temperature with a magnetic stirrer. The electrochemical cell was set up as a three-electrode system with the copper mesh/foam as working electrode, a commercial Ag/AgCl reference electrode and a commercial mesh-type platinized titanium electrode. The reference electrode and the counter electrode were placed in the bath and the current in the cell was switched on.

When sonication was needed, the working electrode (copper mesh/foam substrate) was tied to the tip of the probe type sonicator, near the end, and then dipped in the beaker to complete the electrochemical cell and the electric circuit. The potential at the working electrode was set between −06 to −0.9 V. The sonicator was switched on, to provide pulses of ultrasound waves that created waves in the solution, which in turn vibrated the mesh during the plating process.

After plating the mesh/foam for the time necessary to obtain a thickness of at least 1 μm (the plating time was influenced by the applied potential), the plated mesh/foam was washed with deionized water. Then, the plated mesh/foam was taken out, dried in air and stored under vacuum. More information about the fabrication of silver electrodes could be found on the attached manuscript.

Fabrication of Pt Fluid Permeable Electrodes.

Wire mesh and metallic foam Ag electrodes of various geometries (wire diameter, mesh number) were prepared using a electroplating process (that may or may not need ultrasonication). In brief, gold bath was placed in a water bath maintained at a elevated temperature between (e.g., 70-80° C.) on a hot plate with a magnetic stirrer. The optimum conditions for this bath was 72° C. with mild agitation. After the bath reached optimum temperature, electrochemical cell was set up as a three-electrode system with the copper mesh/foam as working electrode, a commercial Ag/AgCl reference electrode and a commercial mesh-type platinized titanium electrode. The reference electrode and the counter electrode were placed in the bath and the current in the cell was switched on.

When sonication was needed, the working electrode (copper mesh/foam substrate) was tied to the tip of the probe type sonicator, near the end, and then dipped in the beaker to complete the electrochemical cell and the electric circuit. The potential at the working electrode was set between −0.6 to −0.9 V. The sonicator was switched on, to provide pulses of ultrasound waves that created waves in the solution, which in turn vibrated the mesh during the plating process.

After plating the mesh/foam for the time necessary to obtain a thickness of at least 1 μm (the plating time was influenced by the applied potential), the plated mesh/foam was washed with deionized water. Then, the plated mesh/foam was taken out, dried in air and stored under vacuum. More information about the fabrication of platinum electrodes could be found on the attached manuscript.

Fabrication of Ag/AgCl Fluid Permeable Electrode.

Silver/silver chloride permeable electrodes were fabricated using the silver permeable electrodes fabricated as indicate above. More specifically a part of the silver electrode (e.g. from 15-90% of the area) was converted to silver chloride and the remaining part was pure silver. Silver can be converted to silver chloride electrochemically by applying a constant potential slightly above the open circuit potential (OCP) of the electrode in an electrochemical cell with HCl as electrolyte or by using a bleach solution.

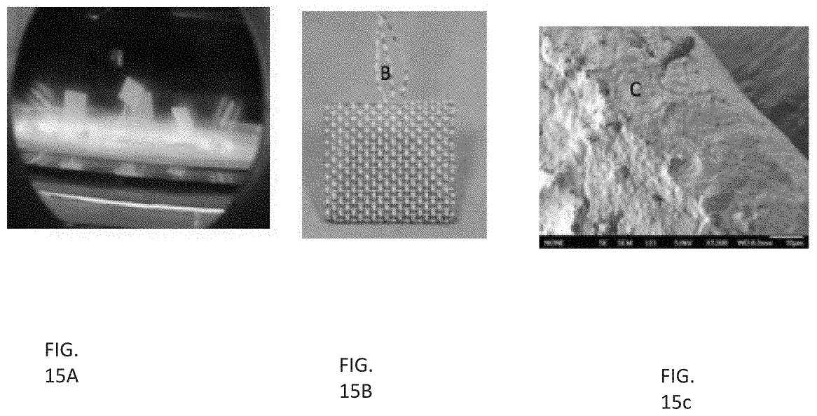

A representative experimental procedure was the following: 50 mV was applied above the OCP for 40 sec in a three-electrode cell, having 0.1M HCl as electrolyte, Pt/Ti as cathode, Ag/AgCl as reference electrode (Fisher Scientific) and the silver mesh electrode as the anode. To check the potential and the stability of the reference electrode that was fabricated, it and and a known standard electrode as the reference electrode (Ag/AgCl (Fisher Scientific)) in a beaker. As an electrolyte a solution of high conductivity was used, such as 3 M NaCl, to lower the potential loss. Then the potential difference was compared, by reading the measurement of a voltammeter. The above process was repeated and the pseudo reference electrode was determined to have a potential of 85 mV versus the conventional Ag/AgCl reference electrode. The FIG. 14A-C shows a photograph of a Ag/AgCl fluid permeable electrode that can be used as reference electrode.

Specifically, FIG. 14A shows a photograph of silver/silver chloride electrode. FIG. 14B shows a SEM image of silver chloride region of the electrode. FIG. 14C shows morphology of silver chloride deposits on the electrode.

Fabrication of Graphene Fluid-Permeable Electrodes.

Graphene is coated as monolayer on the copper substrate using chemical vapor deposition (CVD) process. After cleaning the copper mesh/foam, it is then attached to a copper ring-like structure in vertical position so that the graphene formation takes place uniformly in the CVD chamber (FIG. 15A-C). The Cu meshes on the ring-like structure is transferred to the CVD chamber which is then sealed to create a vacuum; the instrument used for graphene deposition is Aixtron Nanoinstruments Black Magic Pro. Then, N2 and Ar are pumped in the chamber to create an inert atmosphere. The fuel gases used for forming the graphene coating are CH4 and H2. Graphene is formed at 1000° C. and total time of deposition is close to 3 hours (FIG. 15A-C). After graphene coating, the graphene coated mesh/foam (FIG. 15A-C) and ring-like structure showed enhanced brightness. The graphene coating obtained here is a monolayer which is adhered well on the surface (FIG. 15A-C) and does not come off easily. The graphene fluid-permeable electrodes could be further modified to expose functional moieties (metallic nanoparticles, enzymes, conductive polymers, redox mediators etc).

More specifically, FIG. 15A shows an image of the chamber while graphene is deposited on the copper meshes. FIG. 15B shows an image of the graphene permeable electrode. FIG. 15C shows an SEM of graphene deposits on the surface of the copper substrate.

Fabrication of Conductive Polymer Fluid-Permeable Electrodes.

Conductive polymers could be deposited on fluid-permeable substrates using electropolymerization. An example of a conductive polymer that can be deposited is poly(3,4-ethylenodioxythiophene (PEDOT). A platinized Titanium mesh was used as the substrate to deposit PEDOT. The mesh was cleaned for electroplating by sonicating in acetone, ethanol and deionized water for 5 minutes each. After the mesh was cleaned, it was air dried and ready to be plated. A plating solution consisting of EDOT monomer, deionized water and surfactant was made. An aqueous solution of water-surfactant was prepared by adding 10 mg of surfactant (SDS) in 28 mL of deionized water and stirring with a magnetic stirrer for 1 hour. Next, 100 mg of EDOT monomer was weighed and added to the above solution and again stirred for 1 hour to form a homogeneous solution of water-surfactant-monomer. A three-electrode cell consisting of Pt—Ti counter electrode, Ag/AgCl (satd. KCl) reference electrode and Pt—Ti working electrode was formed and a constant potential of 1.2 V was applied for 30 mins with good magnetic stirring to produce a uniform coating of PEDOT on the Pt—Ti working electrode (FIGS. 1H and 1I).

Another example of a conductive polymer that as deposited on a fluid permeable substrate is polyaniline (PANI). A platinized Titanium mesh was used (FIGS. 1H and 1I) as the substrate to deposit PANI. The mesh was cleaned for electroplating by sonicating in acetone, ethanol and deionized water for 5 minutes each. After the mesh was cleaned, it was air dried and ready to be plated. A plating solution consisting of 0.5 M H2SO4 and 0.2 M C6H5NH2 were used; the solution was stirred using a magnetic stirrer for 1 hour before use. It was then transferred to a three-electrode electrochemical cell consisting of Pt—Ti counter electrode, Ag/AgCl (satd. KCl) reference electrode and Pt—Ti working electrode. The potential of deposition was 0.9 V for 1 hour, using good agitation. After electro-polymerization, the mesh substrate was then transferred to a petri dish and dried in an oven at 40° C. for 1 hour. This step improves the adhesion of the polymer to the substrate. PANI was electrodeposited on the Pt—Ti substrate by scanning the potential of the substrate between −0.2 to 0.9 V for 71 cycles; scan rate 20 mV/s.

Fabrication of Stainless Steel Fluid-Permeable Electrodes.

Stainless steel fluid-permeable electrodes can be easily fabricated from stainless steel mesh or foam. For example, a stainless still mesh (e.g., mesh number: 60; wire diameter: 0.01651 cm; opening size: 0.0254 cm) was used to fabricate z permeable electrode. A stainless steel fluid-permeable electrode could be used as counter electrode in an electrochemical cell; rods of stainless steel has been used as counter electrodes in the literature. The stainless steel mesh received from the vendor was cut into a square frame 6.25 mm×6.25 mm leaving three wires in the middle of the strip, along the length of the strip. These three wires were then twisted to form the tail of the electrode. Then the electrode has been cleaned based on the standard cleaning procedures (electrochemical cleaning etc.)

Electrochemical Characterization of Fluid Permeable Electrodes.

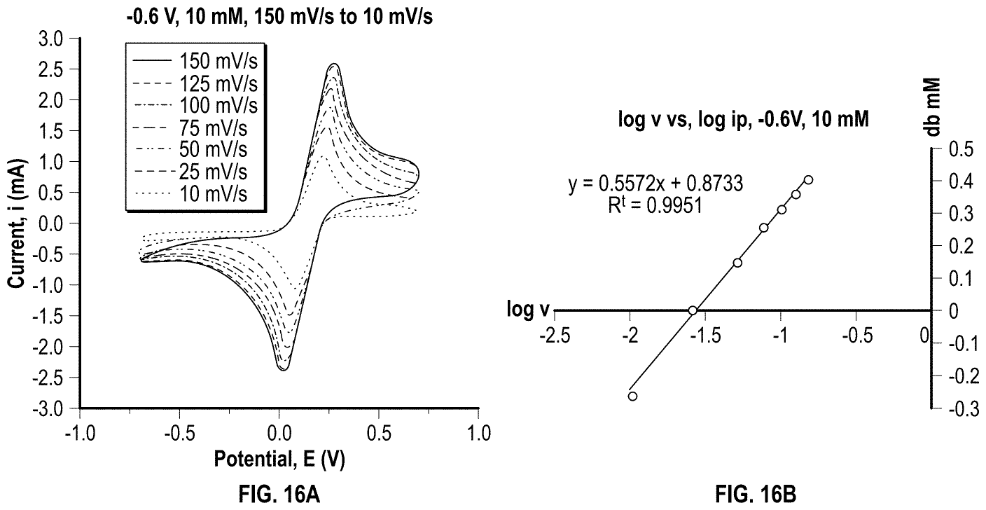

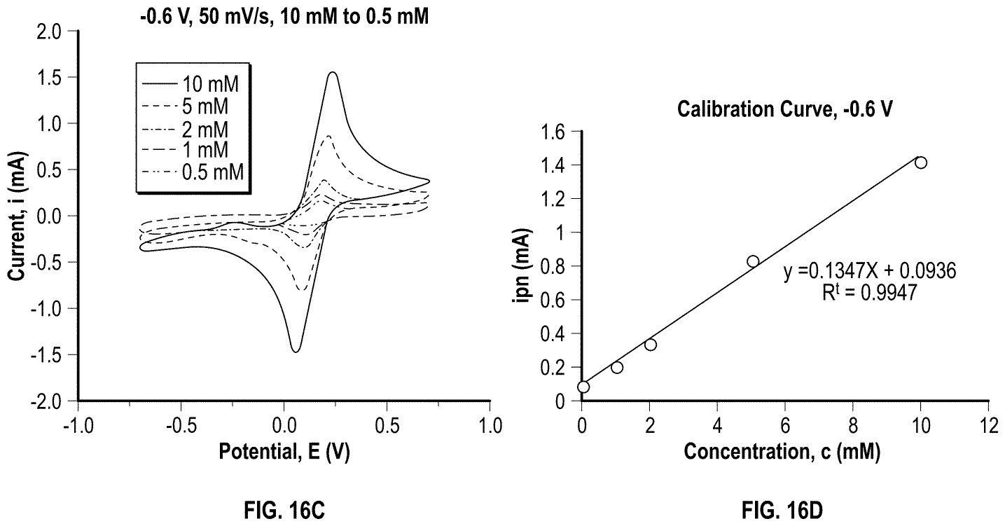

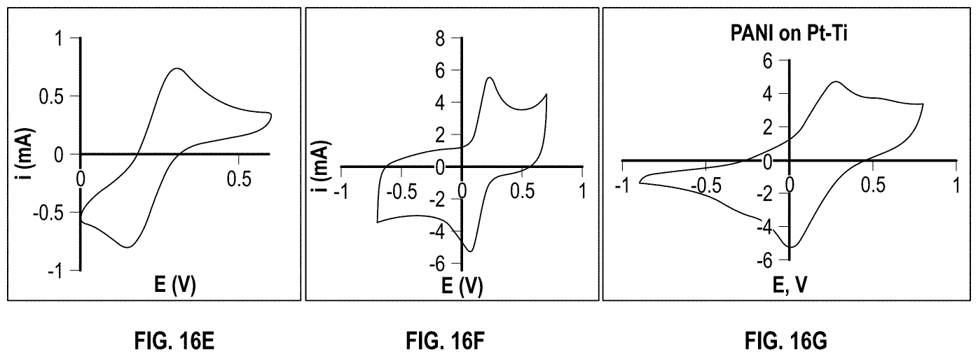

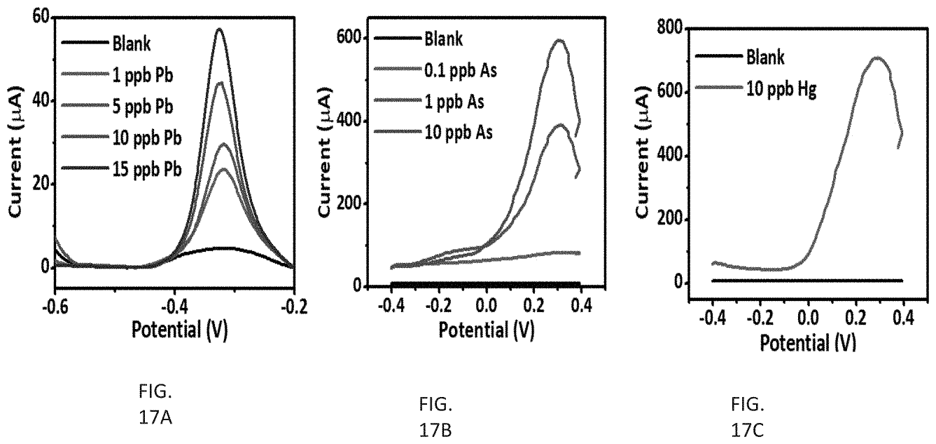

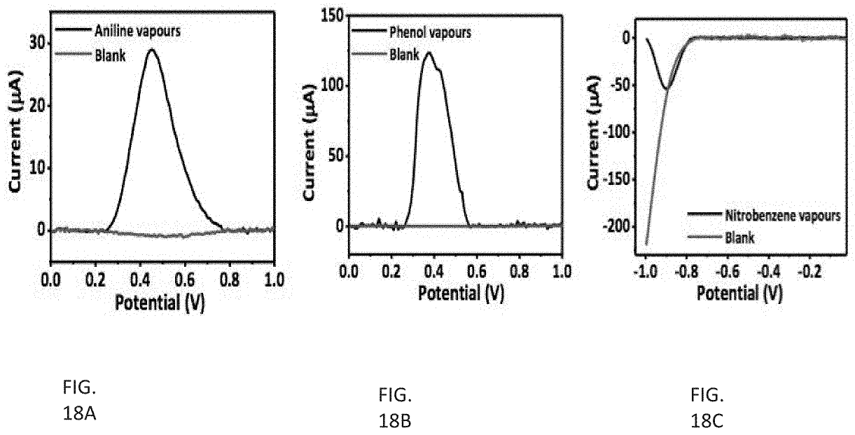

The surface of all the fluid permeable electrodes that are described in this invention is composed of a thin film of the electroactive material (noble metals, conducting polymers, graphene etc.) therefore the electrochemical properties of the electrodes are influenced by the electrochemical properties of the electroactive surface material and the geometry of the structure. For example the electrochemical properties of gold fluid permeable wire electrodes was tested using cyclic voltammetry. Cyclic voltammograms were recorded in solutions of K3Fe(CN)6 and K4Fe(CN)6 in 0.1 M KCl (aq.). In a solution containing 5 mM of each mediator, scans were carried out at 0.15 V/s, 0.125 V/s, 0.1 V/s, 0.075 V/s, 0.05 V/s, 0.025 V/s, and 0.01 V/s between −0.7 and 0.7 V. In all the other concentrations, scans were carried out at 0.05 V/s between −0.7 and 0.7 V. The results of this analysis are depicted in FIG. 16A-G. It was concluded that: i) Electroplating process can be easily controlled to provide the required roughness to the substrate which is higher than that of commercially available gold rod and gold mesh electrodes. ii) The electrodes have a quasi-reversible electrochemical behavior and perform like macroelectrodes. More detailed electrochemical characterization of the various noble metals fluid permeable electrode could be found in the attached manuscript.

The electrochemical properties of the graphene, PEDOT and PANI permeable electrodes were also studied by recording the cyclic voltamogram of solutions of K3Fe(CN)6 and K4Fe(CN)6 in 0.1 M KCl (aq.); the concentration of [Fe(CN)6]4—and [Fe(CN)6]3—was 5 mM each (FIG. 16A-G). It was concluded that the PEDOT permeable electrode was electroactive and could be used as graphene, PEDOT and PANI permeable electrodes for electroanalysis and electrocatalysis.

More specifically, FIG. 16A shows cyclic voltammograms in solution of 5 mM K3Fe(CN)6 and K4Fe(CN)6 in 0.1 M KCl at various scan rates for Au-plated Cu mesh at −0.6 V. FIG. 16B shows a logarithmic of the intensity of anodic peak current (iₚₐ) vs. scan rate for Au-plated Cu mesh at −0.6 V FIG. 16C shows cyclic voltammograms in solutions of K3Fe(CN)6 and K4Fe(CN)6 in 0.1 M in various concentrations, 50 mV/s for Au-plated Cu mesh at −0.6 V. All measurements vs. Ag/AgCl electrodes, Platinized Titanium counter electrode. FIG. 16D shows a calibration line peak current vs. concentration of K3Fe(CN)6/K4Fe(CN)6 in 0. M KCl for Au plated Cu mesh at −0.6 V. All measurements vs. Ag/AgCl electrode. Platinized Titanium counter electrode.

FIGS. 16E-G show a cyclic voltammogram of mixture of 5 mM K3Fe(CN)6 and K4Fe(CN)6 in 0.1 M KCl from the graphene (FIG. 16E), PEDOT (FIG. 16F), or PANI (FIG. 16G) permeable working electrodes; scan rate was equal to 50 mV/s.

Applications of Fluid Permeable Electrodes in Electroanalysis and Electrocatalysis

Electrodes in Conventional Beaker-Type Electrochemical Cells.

The three-dimensional, fluid-permeable electrodes can be used instead conventional electrodes (composed of noble metals, graphene, conductive polymers etc.) in any conventional electrochemical cell (e.g., beaker-type electrochemical cells, small volumes electrochemical cells, H-type electrochemical cells, flow-cell). Examples of the use of fluid permeable electrodes in conventional beaker-type electrochemical cells are now described. More specifically, it is shown that i) Au, Pt and Ag-plated mesh and foam electrodes could monitor the concentration of redox mediators FIG. 16 commonly used in numerous chemical and biochemical assays, ii) Ag-plated mesh electrode could be used as working electrode for the detection of lead ions using square wave anodic stripping voltammetry (SWASV) FIG. 2A, iii) Au-plated mesh electrode could be used as working electrode for the detection of nitro compounds using cathodic differential pulse voltammetry (DPV) FIG. 2C and iv) Pt-plated mesh electrode could be used as working electrode for methanol oxidation in fuel-cells. Pt-plated electrodes (i.e., wire mesh, helix wire mesh, origami wire-mesh, foam electrodes) could also be used as counter electrodes in various electrochemical cells. The attached manuscript describes in great detail the performance of the fluid-permeable mesh/foam noble metals electrodes in a conventional beaker-type electrochemical cell. Preliminary experiments have shown that fluid-permeable electrodes can also detect other hazardous heavy metal ions (e.g., mercury, arsenic) at ppb levels, several polar organic compounds (amino- and hydroxyl-compounds, thiols, dopamine).

Electrodes in Flow Electrochemical Cells.

The three-dimensional, open cell electrodes (e.g., wire mesh, metallic foam) are fluid permeable so they can be used in flow-cell electrochemical cells. Flow cells typically used in electroanalytic and electrocatalytic applications use planar electrodes and the fluids (gases or liquids) pass on top of the electrodes. The fluid permeable electrodes will allow the fluids (gases or liquids) to pass through so they can allow higher mass transport of chemicals onto the electrode that might result in better electrochemical performance in several systems. In the embodiment, a fluid permeable electrochemical cell is especially designed for fluid permeable electrodes.

Design and Fabrication of Fluid-Permeable Electrochemical Cells (Fluid-Permeable ECCs).

Fluid-permeable ECCs contain one or more fluid-permeable electrodes inside a compartment (made of plastic, glass or metal) that has an inlet port and an outlet port. The performance of the cell depends mainly on the electrodes (dimensions, electroactive material, porosity). The physical and chemical properties of the separation membrane (thickness, porosity and chemical inertness) influence in part the performance as a) the thickness needs to be as small as possible to keep electrodes in a small distance and increase the signal to noise ration, b) the porosity needs to be big enough, to allow the sample to flow through the filter and be in contact with all the three electrodes, creating a continuous electrolyte medium without any pressure drop taking place, and c) the chemical inertness is necessary to ensure that the material will not interfere with the analysis.

One example of a fluid permeable ECC is shown in FIGS. 5A and 5B which respectively show an image and schematic of a cell. In this prototype three fluid-permeable electrodes (i.e., a working electrode (WE), a counter electrode (CE) and a pseudo-reference electrode (RE)) and separation O-rings (paper or fabric can be also used) for the space separation of the electrodes all placed inside a plastic filter holder; fluid-permeable electrodes are placed perpendicular to the fluidic flow and allow the sample to pass through them. The shape of a filter-like ECC allows syringes, syringe filters and plastic tubes to be connected to it and reagents to be stored inside it if needed. Fluid-permeable ECCs have the following advantages compared to conventional flow electrochemical cells: (a) They do not require pumps for fluidic flow; the samples could be delivered and pushed through the cell using a syringe. (b) They can contain necessary reagents for the electrochemical system to be released only when the fluid passes through the cell. (c) They can be easily connected to syringe filters in series. (d) They can be easily connected in series. (e) They could be inexpensive; filter-like ECCs could be prepared by using low-cost, fluid-permeable plated electrodes and 3D printed plastic compartments. (f) They will exhibit unmatched sensitivity especially when the electrochemical assays bioassays require the preconcentration of the analyte on the electrodes; fluid permeable electrodes allow the maximum possible interaction between the sample and the electrodes which could greatly facilitate the preconcentration of analyte on the electrode.

Applications of Fluid Permeable Electrochemical Cells in Electroanalysis and Electrocatalysis

Fluid-permeable electrochemical cells could be used in a number of setting such as: a) a electrochemical cell for in-field diagnostics and environmental analysis, b) as flow cell for industrial flow based analysis, and c) flow cell for water/waste treatment.

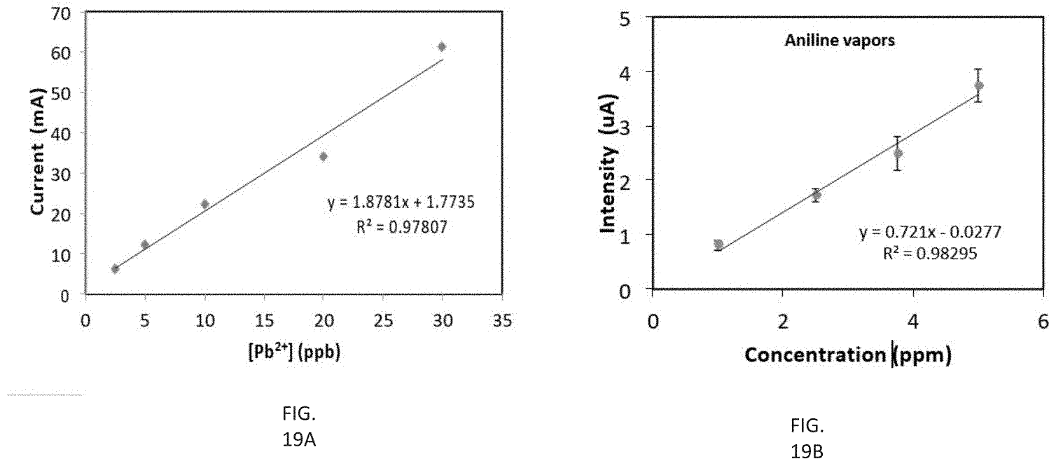

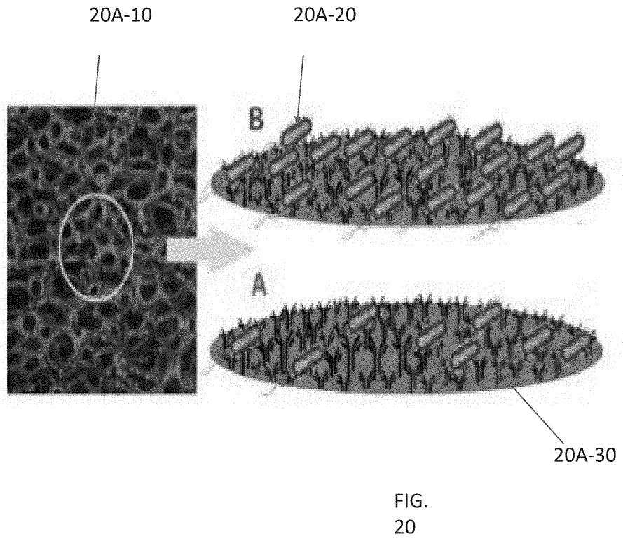

A number of examples are provided of use of the fluid-permeable electrochemical cells in electroanalysis and electrocatalysis. For example fluid-permeable ECCs can be used for the detection of hazardous heavy metal ions (lead, mercury, arsenic) at ppb levels (FIGS. 17A-C, which show oxidation levels of solutions of heavy metals obtained using filter-like ECCs) and vapors of polar compounds (amino-, nitro-, and hydroxyl-compounds) (FIGS. 18A-C, which show oxidation peaks of vapors of volatile compounds recorded on filter-like). More specifically, filter-like ECC for lead sensing uses a Ag wire mesh as WE and the filter-like ECCs for arsenic and mercury sensing uses a filter-like ECCs with an Au wire mesh as WE; stainless steel wire mesh was used as CE and Ag/AgCl electroplated wire mesh as pseudo RE in both cases. Both sensors use anodic stripping voltammetry (SWASV) for detection purposes; before electrochemical detection the heavy metal ions are reduced to elemental metals in a 60 s deposition step while 5 mL of the tested solutions flows through the filter-like electrochemical cell. Detailed experiments with fluid-permeable ECCs for lead detection have concluded that the fluid-permeable ECCs can detect lead ions in aqueous samples down to sub ppb levels (FIG. 19A, which shows calibration curves for the detection of lead ions using fluid-permeable ECCs). Detailed experiments with fluid-permeable ECCs for aniline vapors in air samples have concluded that the fluid-permeable ECCs (that us a graphene fluid permeable electrode as WE) can detect aniline down to sub ppm levels (FIG. 19B, which shows. Calibration curves for the detection of aniline vapors using fluid-permeable ECCs).

Examples of uses of fluid permeable ECCs in water/waste treatment have been performed. More specifically, a fluid permeable ECC is developed for water disinfection that may be the core element of new well's water disinfection systems. The fluid permeable ECCs fabricated using a commercially available filter-holder that house two Pt-metallic foam fluid permeable electrodes (as counter and working electrodes) separated by a rubber O-ring have been used to decontaminate water samples from live bacteria. Water samples that contained bacteria up to 25000 CFU/mL spiked with H2O2 (down to 10 ppm) before treatment and then passed through the fluid-permeable ECCs. By just flowing through the ECCs (FIG. 7E, showing the use of fluid-permeable ECC for bacteria killing to decontaminate water samples) when low voltage (down to −0.6 V) was applied the bacteria were killed (100% killing efficiency) and the water samples were decontaminated. The killing the bacteria is caused by the ROS caused due to electrocatalytic decomposition of hydrogen peroxide on top of the fluid permeable electrodes. The bacteria are also forced to pass in very closed proximity to the electrodes surface (as they must pass through the electrodes) so the bacteria killing is very effective. Other fluid permeable electrodes and active elements (HOCl etc) could be also used to decontaminate water/waste samples from bacteria, virus, pesticides and other pollutants.

Design, Fabrication and Applications of Fully Integrated, Fluid-Permeable Analytical Devices for in Field Chemical and Biochemical Analysis.

The design of the filter-like electrochemical cell ensures that the maximum amount of the sample will interact with the electrodes while the sample flows inside the cell and through the electrodes. The design of the filter-like electrochemical cell also ensures that the filter-like electrochemical cell can be easily connected to a) a syringe to deliver a sample (e.g., blood, environmental sample, etc. to the cell; b) a series of commercially available or costume made filters and compartments to remove interferences (e.g., red blood cells, dirt, particulates, proteins etc.) or to store the necessary reagents for the analysis (the reagents will be released when the fluid pass through that compartment) c) other flow based detectors (photometric flow detectors, luminescence detectors etc.). This connectivity with various analytical tools (filters, syringes, low detectors etc) provides unique opportunities for the development of fully integrated fluid permeable analytical devices. For example fully integrated devices for the detection of hazardous metals (Pb, Cd, As, Hg) have been developed (FIG. 7A). The devices include a fluid-permeable electrochemical cell that is contained with a plastic compartment that hold the necessary reagents (e.g., acids, salts) prestored; the reagents will be hydrated and mixed with the sample upon sample addition. The plastic compartment is connected with a syringe filter for sample filtering. The user can simply pass the sample through the fully integrated device and all the steps of the assay will be performed automatically (sample, filtering, reagents addition, electrochemical detection). A similar setup has been designed for the detection of metals (Zn, Pb) in blood samples. In this case the syringe filter contains a blood separation membrane or other filtering material to filter out red blood cells.

Fully integrated devices for the detection of bacteria in water, food samples and urine have been also designed. The detection of bacteria in water samples and juices samples has been performed by performing electrochemical immunoassays in fluid-permeable ECCs. The protocol have a bacteria preconcentration step where bacteria are captured/preconcentrated on the surface of a fluid permeable substrate (e.g., membrane, metallic mesh/foam etc.), a bacteria labeling step where the captured bacteria react with detection antibodies labeled with nanolabels (enzymes, metallic quantum dots etc), and a signal amplification/detection step where the products of the nanolabels are detected electrochemically. For example an immunoassay performed in fluid-permeable device is based on a) the preconcentration of bacteria (E. coli ORN 178) on the PVDF syringe, b) coupling of bacteria with biotinylated anti-E. coli antibodies, c) labeling of bacteria with streptavidin-horseradish peroxidase conjugates, d) enzymatic modification of Amplex Red into redox active resorufin, and e) electrochemical detection of resorufin using square wave voltammetry (between −0.3V to 0.3V, and monitoring the peak at −0.2V) on a fluid permeable ECCs.

Fully integrated, fluid-permeable ECCs have been designed also for the ultrasensitive detection of bacteria. For example, the main steps of these ultrasensitive assay are the following: (FIG. 1.) a) bacteria preconcentration on the fluid permeable substrate (e.g., PVD membrane), b) culturing of bacteria trapped on the fluid permeable substrate using broth media, c) bacteria labeling with reporter antibodies that contain nanolabels (HRP or Cd nanoparticles) that allow signal amplification, and d) a sensitive electrochemical detection step to detect the products of an enzymatic reaction of HRP or Cd ions produced from the acid dissolution of Cd nanoparticles. All the steps of the immunoassay are performed inside the biosensor (i.e., fluid-permeable ECC).

Multi-array fluid-permeable ECCs can also allow high throughput analysis of water and food samples for pathogenic bacteria. Multi-array fluid-permeable ECCs will be consisted of microtiter-filter plates (e.g., MultiScreen® Plates that contain Durapore® Membranes), a vacuum manifold to facilitate liquid handing, and 96 well plates micrototiter plates that contain a set of screen printed electrodes in each well. Various 3D printed attachments that are connected to the above parts allow the analysis of large sample volumes. The multi-array filter-like biosensors could perform both versions of fluid-permeable electrochemical immunoassays (regular and ultrasensitive) in a way that would be easy for the end user.

Fully-integrated fluid-permeable ECCs for the detection of bacteria in urine have been also designed. In this case, fluid-permeable ECC that contain fluid-permeable electrodes (e.g., gold-plated metallic foam electrodes or polyaniline permeable electrodes) functionalized with anti-bacteria specific antibodies are used. When the sample (urine) that contain bacteria will be pass through the fluid-permeable electrodes then bacteria will be trapped on the surface of the electrodes and change the charge-transfer resistance (Rct) values measured from Nyquist plots. The change in charge-transfer resistance (Rct) values will be correlated to the number of bacteria in the sample (FIG. 20, showing a schematic of the bioassay for bacteria detection).

Fully integrated fluid-permeable ECC for the detection detection of volatile compounds in air sample or food samples has been designed to be composed of a fluid-permeable ECC (that uses a graphene fluid-permeable electrode as working electrode) and a syringe filled with an electrolyte solution. The fluid-permeable ECC will be connected to an air sampling pump that force air to pass through the fluid permeable electrodes. Volatile compounds will be immobilized on the surface graphene-working electrode. After sampling the user will just have to connect the syringe to the fluid-permeable ECC to fill it with the electrolyte solution. The electrochemical protocol will then performed and electroanalytical signals proportional to the concentrations of the volatile compounds will be recorded.

In sum, the embodiments utilize fluid permeable electrochemical cells in sensors, devices and applications indicated above. The fluid permeable electrochemical cells are distinctly different from conventional electrochemical cells because of their design, shape, and use of fluid permeable electrodes that exhibit high accessible surface per unit of mass of electrode material and per unit of projected area of the electrode. Fluid permeable electrochemical cells are also distinctly different than conventional flow electrochemical cells because a) their unique design, b) they drive the fluids to pass through one or more fluid permeable electrodes; and c) they can be readily connected to other laboratory tools (tubing, syringes, syringe filters etc.).

In each of the embodiments discussed herein, the leads of the electrodes receive power or electric potential via the potentiostat or a power source such as a battery or other common power source. This enables the cell to function as a sensor, due to electrochemical reactions with the reagents in solution, or generate the catalytic reactions discussed herein.

According to one aspect of the embodiments, disclosed is a fluid-permeable electrode having an open-cell structure and including: a layer of an electroactive material deposited on a surface of an open cell substrate that is formed of a material that differs from the electroactive material; or a fluid-permeable electrode having an open-cell structure and consisting of an electroactive material.

According to another aspect of the embodiments, and in addition to one or more of the disclosed aspects of the fluid-permeable electrode, the open cell substrate includes: mesh or foam, screen or cloth; and the open cell substrate includes one or more of: copper and its alloys; brass; nickel and its alloys; iron and its alloys; steel; stainless steel; and transition series metals including one or more of: alloys of transition metals; alloys of metals; pure gold; pure silver; and pure platinum.

According to another aspect of the embodiments, and in addition to one or more of the disclosed aspects of the fluid-permeable electrode the electroactive material includes gold, silver, platinum, silver chloride, a noble metal, noble metal alloy, transition metal, transition metal alloy, graphene, carbon nanotubes, or an electroconductive polymer.

According to another aspect of the embodiments, and in addition to one or more of the disclosed aspects of the fluid-permeable electrode the electroactive material further includes nanoparticles, or zeolites.

According to another aspect of the embodiments, and in addition to one or more of the disclosed aspects of the fluid-permeable electrode the layer of electroactive material is applied by screen printing, electrodeposition, electroless deposition, chemical vapor deposition, dip coating, sputtering, or atomic layer deposition.

According to another aspect of the embodiments, disclosed is a device including one or more of the fluid-permeable electrodes disclosed herein, integrated into a fabric, paper, or plastic film substrate.

According to another aspect of the embodiments, the device disclosed herein may be in the form of an analyte sensor to detect a biomolecule, metabolite, an enzyme, a protein, an antibody, a metal, metallic ions, bacteria, pesticides, or an organic pollutant or organic compounds.

According to another aspect of the embodiments, disclosed is a fluid-permeable electrochemical cell (ECC), including one or more of the fluid-permeable electrodes disclosed herein; and a fluid, wherein the electrode and the fluid are disposed inside a compartment including an inlet port and an outlet port, and wherein the fluid is a gas or liquid.

According to another aspect of the embodiments, disclosed is a fluid-permeable analytical device for the detection of an analyte, biomolecule, metabolite, an enzyme, a protein, an antibody, a metal, metallic ions, bacteria, pesticides, or an organic pollutant or organic compounds, the device including the fluid-permeable electrochemical flow cell disclosed herein.

According to another aspect of the embodiments, disclosed is a fluid-permeable device for the decontamination of aqueous fluids, including the fluid-permeable electrochemical flow cell disclosed herein.

According to another aspect of the embodiments, disclosed is a device including: the ECC disclosed herein, operatively coupled to a syringe, with a sample in solution disposed therein and a reagent disposed in the solution, wherein the ECC is electrically coupled to a electrochemical analyzer, which is operatively connected to an electronic device, whereby the device is configured to capture information regarding the sample while the solution is urged out of the syringe and through the ECC.

According to another aspect of the embodiments, and disclosed is a method of detecting analyte in liquid samples, including: filling the syringe of the device disclosed herein with a liquid sample of one or more of environmental water; drinking water; food extracts; liquid beverage; liquid food sample; whole blood; serum; urine; and plasma, wherein the reagent is either a liquid form or embedded a reagent support substrate; urging the liquid sample through the ECC, thereby determining via an electrochemical analyzer, a concentration of one or more analyte in the liquid sample, the one or more analyte including biomolecule, metabolite, an enzyme, a protein, an antibody, a metal, metallic ions, bacteria, pesticides, or an organic pollutant or organic compounds; and graphing data representing the output of the electrochemical analyzer on the external device to thereby illustrate the concentration.

According to another aspect of the embodiments, disclosed is a device including: the ECC disclosed herein, operatively coupled to a conduit for receiving a gas, and configured for being decoupled from the conduit after receiving the gas and then being operatively coupled to a syringe with a solution disposed therein and a reagent disposed in the solution, wherein the ECC is electrically coupled to an electrochemical analyzer, which is operatively connected to an electronic device, whereby the device is configured to capture information regarding the gas while the solution is urged out of the syringe and through the ECC.

According to another aspect of the embodiments, disclosed is a method of detecting analyte in a gas, including: directing a gas into the conduit of the device disclosed herein, wherein the reagent is either a liquid form or embedded a reagent support substrate; decoupling the conduit from the ECC and coupling the syringe to the ECC; and urging the solution through the ECC, thereby determining via electrochemical analyzer a concentration of one or more analyte in the gas, the one or more analyte including an organic pollutant or organic compounds, and graphing data representing the output of the electrochemical analyzer on the external device to thereby illustrate the concentration.

According to another aspect of the embodiments, disclosed is a device including: the ECC disclosed herein, operatively coupled to a fluid supply and in fluid communication with a disinfectant, wherein the ECC is electrically coupled to a power source, whereby the device is configured to decontaminate the fluid gas while the fluid is urged out of the syringe and through the ECC.

According to another aspect of the embodiments, disclosed is a method of disinfecting a fluid, including: urging the fluid through the ECC of the device disclosed herein, thereby decontaminating the fluid; and collecting from the ECC the fluid that is decontaminated.

According to another aspect of the embodiments, disclosed is a method of performing a catalytic conversion, including: placing electrodes disclosed herein in a beaker or H-cell, or fluid permeable cell, and engaging the electrodes with a reagent mixture, and providing power to the electrodes.

According to another aspect of the embodiments, disclosed is a device including: a plurality of the cells disclosed herein, connected in series, including a first cell with a first inlet port; a fluid supply connected directly or indirectly via tubing to the first inlet port on the first cell, wherein the plurality of cells are electrically coupled to an electrochemical analyzer, which is operatively connected to an electronic device, wherein each of the cells includes a respectively unique set of the electrodes, so that the device is configured to detect a plurality of analytes.

According to another aspect of the embodiments, disclosed is a device including the cell disclosed herein, connected via tubing to a pump and a fluid reservoir, and an electrochemical analyzer, wherein the device is configured as an electrochemical detection flow detection cell.

According to another aspect of the embodiments, disclosed is a fluid flow control device including a fluid tube wrapped around a core so that the tube turns and twists about the core, wherein the fluid tube defines an input and an output flow rate.

Sensor data identified herein may be obtained and processed separately, or simultaneously and stitched together, or a combination thereof, and may be processed in a raw or complied form. The sensor data may be processed on the sensor (e.g. via edge computing), by controllers identified or implicated herein, on a cloud service, or by a combination of one or more of these computing systems. The senor may communicate the data via wired or wireless transmission lines, applying one or more protocols as indicated below.

Wireless connections may apply protocols that include local area network (LAN, or WLAN for wireless LAN) protocols. LAN protocols include WiFi technology, based on the Section 802.11 standards from the Institute of Electrical and Electronics Engineers (IEEE). Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance and is a media access control (MAC) layer protocol for transferring management and application messages between a network server and application server, respectively. LAN and WAN protocols may be generally considered TCP/IP protocols (transmission control protocol/Internet protocol), used to govern the connection of computer systems to the Internet. Wireless connections may also apply protocols that include private area network (PAN) protocols. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz—typically in the 769-935 MHz, 315 Mhz and the 468 Mhz frequency range. This spectrum band below 1 Ghz is particularly useful for RF IOT (internet of things) applications. The Internet of things (IoT) describes the network of physical objects—“things”—that are embedded with sensors, software, and other technologies for the purpose of connecting and exchanging data with other devices and systems over the Internet. Other LPWAN-IOT technologies include narrowband internet of things (NB-IOT) and Category M1 internet of things (Cat M1-IOT). Wireless communications for the disclosed systems may include cellular, e.g., 2G/3G/4G (etc.). Other wireless platforms based on RFID technologies include Near-Field-Communication (NFC), which is a set of communication protocols for low-speed communications, e.g., to exchange date between electronic devices over a short distance. NFC standards are defined by the ISO/IEC (defined below), the NFC Forum and the GSMA (Global System for Mobile Communications) group. The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

When data is transmitted over a network between end processors as identified herein, the data may be transmitted in raw form or may be processed in whole or part at any one of the end processors or an intermediate processor, e.g., at a cloud service (e.g. where at least a portion of the transmission path is wireless) or other processor. The data may be parsed at any one of the processors, partially or completely processed or complied, and may then be stitched together or maintained as separate packets of information. Each processor or controller identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random-access memory (RAM), read only memory (ROM), or other electronic, optical, magnetic or other computer readable medium.

The controller may further include, in addition to a processor and non-volatile memory, one or more input and/or output (I/O) device interface(s) that are communicatively coupled via an onboard (local) interface to communicate among other devices. The onboard interface may include, for example but not limited to, an onboard system bus, including a control bus (for inter-device communications), an address bus (for physical addressing) and a data bus (for transferring data). That is, the system bus may enable the electronic communications between the processor, memory, and I/O connections. The I/O connections may also include wired connections and/or wireless connections identified herein. The onboard interface may have additional elements, which are omitted for simplicity, such as controllers, buffers (caches), drivers, repeaters, and receivers to enable electronic communications. The memory may execute programs, access data, or lookup charts, or a combination of each, in furtherance of its processing, all of which may be stored in advance or received during execution of its processes by other computing devices, e.g., via a cloud service or other network connection identified herein with other processors.

Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A fluid-permeable electrode having an open-cell structure and comprising:
a layer of an electroactive material deposited on a surface of an open cell substrate that is formed of a material that differs from the electroactive material; or
a fluid-permeable electrode having an open-cell structure and consisting of an electroactive material.

2. The fluid-permeable electrode of claim 1, wherein
the open cell substrate comprises: mesh or foam, screen or cloth; and
the open cell substrate comprises one or more of:
copper and its alloys; brass; nickel and its alloys; iron and its alloys; steel; stainless steel; and transition series metals including one or more of: alloys of transition metals; alloys of metals; pure gold; pure silver; and pure platinum.

3. The fluid-permeable electrode of claim 1, wherein
the electroactive material comprises gold, silver, platinum, silver chloride, a noble metal, noble metal alloy, transition metal, transition metal alloy, graphene, carbon nanotubes, or an electroconductive polymer.

4. The fluid-permeable electrode of claim 1, wherein
the electroactive material further comprises nanoparticles, or zeolites.

5. The fluid-permeable electrode of claim 1, wherein
the layer of electroactive material is applied by screen printing, electrodeposition, electroless deposition, chemical vapor deposition, dip coating, sputtering, or atomic layer deposition.

6. A device comprising
one or more of the fluid-permeable electrodes of claim 1, integrated into a fabric, paper, or plastic film substrate.

7. The device of claim 6, in the form of an analyte sensor to detect a biomolecule, metabolite, an enzyme, a protein, an antibody, a metal, metallic ions, bacteria, pesticides, or an organic pollutant or organic compounds.

8. A fluid-permeable electrochemical cell (ECC), comprising
one or more of the fluid-permeable electrodes of claim 1; and
a fluid, wherein the electrode and the fluid are disposed inside a compartment comprising an inlet port and an outlet port, and wherein the fluid is a gas or liquid.

9. A fluid-permeable analytical device for the detection of an analyte, biomolecule, metabolite, an enzyme, a protein, an antibody, a metal, metallic ions, bacteria, pesticides, or an organic pollutant or organic compounds, the device comprising the fluid-permeable electrochemical flow cell of claim 8.

10. A fluid-permeable device for the decontamination of aqueous fluids, comprising the fluid-permeable electrochemical flow cell of claim 8.

11. A device comprising:
the ECC of claim 8, operatively coupled to a syringe, with a sample in solution disposed therein and a reagent disposed in the solution, wherein the ECC is electrically coupled to a electrochemical analyzer, which is operatively connected to an electronic device, whereby the device is configured to capture information regarding the sample while the solution is urged out of the syringe and through the ECC.

12. A method of detecting analyte in liquid samples, comprising:
filling the syringe of the device of claim 11 with a liquid sample of one or more of environmental water; drinking water; food extracts; liquid beverage; liquid food sample; whole blood; serum; urine; and plasma,
wherein the reagent is either a liquid form or embedded a reagent support substrate;
urging the liquid sample through the ECC, thereby determining via an electrochemical analyzer, a concentration of one or more analyte in the liquid sample, the one or more analyte including biomolecule, metabolite, an enzyme, a protein, an antibody, a metal, metallic ions, bacteria, pesticides, or an organic pollutant or organic compounds; and
graphing data representing the output of the electrochemical analyzer on the external device to thereby illustrate the concentration.

13. A device comprising:
the ECC of claim 8, operatively coupled to a conduit for receiving a gas, and configured for being decoupled from the conduit after receiving the gas and then being operatively coupled to a syringe with a solution disposed therein and a reagent disposed in the solution, wherein the ECC is electrically coupled to an electrochemical analyzer, which is operatively connected to an electronic device, whereby the device is configured to capture information regarding the gas while the solution is urged out of the syringe and through the ECC.

14. A method of detecting analyte in a gas, comprising:
directing a gas into the conduit of the device of claim 13,
wherein the reagent is either a liquid form or embedded a reagent support substrate;
decoupling the conduit from the ECC and coupling the syringe to the ECC; and
urging the solution through the ECC, thereby determining via electrochemical analyzer a concentration of one or more analyte in the gas, the one or more analyte including an organic pollutant or organic compounds, and
graphing data representing the output of the electrochemical analyzer on the external device to thereby illustrate the concentration.

15. A device comprising:
the ECC of claim 8, operatively coupled to a fluid supply and in fluid communication with a disinfectant, wherein the ECC is electrically coupled to a power source, whereby the device is configured to decontaminate the fluid gas while the fluid is urged out of the syringe and through the ECC.

16. A method of disinfecting a fluid, comprising:
urging the fluid through the ECC of the device of claim 15, thereby decontaminating the fluid; and
collecting from the ECC the fluid that is decontaminated.

17. A method of performing a catalytic conversion, comprising: placing electrodes of claim 1 in a beaker or H-cell, or fluid permeable cell, and engaging the electrodes with a reagent mixture, and providing power to the electrodes.

18. A device comprising:
a plurality of the cells of claim 8, connected in series, including a first cell with a first inlet port;
a fluid supply connected directly or indirectly via tubing to the first inlet port on the first cell,
wherein the plurality of cells are electrically coupled to an electrochemical analyzer, which is operatively connected to an electronic device,
wherein each of the cells includes a respectively unique set of the electrodes,
so that the device is configured to detect a plurality of analytes.

19. A device comprising the cell of claim 8, connected via tubing to a pump and a fluid reservoir, and an electrochemical analyzer, wherein the device is configured as an electrochemical detection flow detection cell.

20. A fluid flow control device including a fluid tube wrapped around a core so that the tube turns and twists about the core, wherein the fluid tube defines an input and an output flow rate.
